(19) United States
(12) Patent Application Publication
(10) Pub. No.: US 2026/0340938 A1
(43) Pub. Date: Oct. 29, 2026

(54) METHODS FOR THE MANAGEMENT, CERTIFICATION, AND DISCOVERY OF DIGITAL AVATARS IN XR SERVICES

(71) Applicant: InterDigital Patent Holdings, Inc., Wilmington, DE (US)

(72) Inventors: Quang LY, North Wales, PA (US); Dale SEED, Allentown, PA (US); Catalina MLADIN, Hatboro, PA (US); Lu LIU, Conshohocken, PA (US)

(73) Assignee: InterDigital Patent Holdings, Inc., Wilmington, DE (US)

(21) Appl. No.: 19/484,469

(22) PCT Filed: May 17, 2024
(86) PCT No.: PCT/US2024/029854

§ 371 Date: Nov. 14, 2025

Related U.S. Application Data
(60) Provisional application No. 63/503,000, filed on May 18, 2023.

(51) Int. Cl. G06T 17/00; G06F 21/31; G06F 21/62

(52) U.S. Cl. CPC G06T 17/00; G06F 21/31; G06F 21/629; G06F 2221/2141

(57) ABSTRACT

Methods, apparatus, and systems are described for management of information associated with digital avatars, including user extended Reality (XR) digital avatar creation and management, user XR digital avatar certification, and/or user XR digital avatar access and storage by third parties.

### CROSS-REFERENCE TO RELATED APPLICATIONS

This application claims the benefit of, and incorporates herein by reference in its entirety, U.S. Provisional Application No. 63/503,000 titled “Methods for the Management, Certification, and Discovery of Digital Avatars in XR Services,” filed May 18, 2024.

### BACKGROUND

Augmented Reality (AR) and Virtual Reality (VR) technologies have been tantalizing users for some time for providing an immersive user experience, especially in the gaming industry. In AR, computer graphics may be overlaid into a real-world view where a user can then interact with the added graphics to obtain more information about an object present in the user's view. VR, on the other hand, presents a user with a computer-generated environment in which the user can interact with other VR users and objects in the virtual world.

In both AR and VR, users may for example participate in a gaming session and feel as if they are part of the action. As examples, the action may be to guide a hero to infiltrate enemy territory, to navigate in a high-speed car chase, or to duel an opponent in a sporting event. The user may interface to the AR/VR application through a wearable device such as glasses, headsets, tactile gloves, and other bodily sensors. Users may transfer audio, visual, and haptic information to the AR/VR application and to another user who may be involved in the gaming session. Other sensors, such as cameras, may also transfer the user's movement data to the AR/VR application and to other users.

An AR/VR service provider may host an application server in cloud or edge networks for which many users may gain access to the AR/VR application regardless of their locations. Users may utilize smartphones and/or AR/VR glasses within a static location or the user may be mobile. The mobile devices may require connectivity provided by a mobile network operator's (MNO) cellular communication system.

extended Reality (XR) is a term used to describe technologies that enhance a user's view of the real and/or virtual world and therefore may encompass AR, VR, or a [1] combination of both. As a result, XR may be used to collectively include AR and VR technologies.

Thus far, XR has been described from the perspective of a single user benefiting from an immersive experience. When multiple users have the same immersive experience, a term commonly used to describe such a scenario is that the users are interacting with the metaverse. Moreover, metaverse may refer to the interactions of multiple XR users simultaneously while providing an immersive experience to each user as if they were all interacting at the same location.

Digital avatars represent users in XR services and offer a medium for users to interact with other XR users, whether it is in augmented or virtual reality environments. For example, an avatar of a user may appear in an augmented reality application. The avatar may be displayed in AR glasses worn by other users. For example, the avatar may represent the user in a virtual environment. The user's avatar may be seen by other users in the XR service while the user sees the other user's avatars, e.g., with each user seeing the avatars of the other users through the use of XR glasses. The avatars may then be able to interact with each other as if all the users are present in the same location and/or environment.

As the name implies, digital avatars are generated digitally and require some form of medium to render the likeness of a user to other users. The medium is typically XR glasses, but it may also be any device that is able to display the information associated with a digital avatar, such as a smartphone, a smart display, a monitor, or even a television. Being digital, an avatar may be created and/or modified to the whims of the user and/or XR service. Therefore, an avatar may represent the actual likeness or caricature of a user, be able to be dressed in digital clothing, and may also have animated capabilities to reflect a user's facial expressions and/or bodily movements. A user may even have multiple avatars with each avatar serving a different purpose, e.g., one for professional interactions, another one for personal use, and a third for online use.

With the emergence of XR services, users may increasingly immerse themselves into the XR services. The primary interface for a user's interaction with XR services is via a digital avatar. The immersive experience of XR services may create powerful links between the physical and digital worlds, creating a need for protection in virtual life (e.g., similar to real life). For example, bullying and harassment occurring within XR services may require mechanisms to [2] protect real users from experiencing bullying or harassment using the XR services. Moreover, for users to navigate the sheer size of the XR universe, users may need to be able to discover and certify the avatar of other XR users actively participating in XR services, with various XR service providers, and/or between different platforms.

### SUMMARY

Described herein are methods, apparatus, and systems for management of information associated with digital avatars, including user XR digital avatar creation and management, user XR digital avatar certification, and/or user XR digital avatar access and storage by third parties.

For example, a method for use by an extended reality client may comprise receiving a message comprising information associated with creating a digital avatar of an XR user. The message may be received from one or more application clients or application servers. The digital avatar may comprise a medium for the XR user to interact with one or more other XR users in or more XR services. Each of the one or more application clients or application servers may be associated with a separate device. The separate device may be one of a smartphone, an external camera, or a wearable sensor device.

The method may further comprise sending a request to create the digital avatar of the XR user. The request may be sent to an XR server. The request may comprise a user identifier configured to facilitate authenticating and authorization of the XR user, and one or more of other user information, an avatar name, an avatar description, information and associated metadata associated with creating the digital avatar of the XR user, an authorization policy, an access control policy, an avatar status, a multi-factor authentication (MFA) level, a verification interval, a discoverable indicator, a discoverable level, a certification resource, a location, a schedule, avatar source information, a family list, a friends list, or an XR service providers list, wherein the avatar source information comprises one or more of a type, metadata, a rendering engine, or avatar data for rendering. The information and associated metadata associated with creating the digital avatar of the XR user may comprise one or more of an image, a video, a location, an audio recording, and one or more sensor measurements. One or more other users identified in one of the family list, the friends list, or the XR service provider list may have [3] access to the avatar of the XR user. The other user information may comprise one or more of a name associated with the XR user, an address associated with the XR user, height associated with the XR user, weight associated with the XR user, date of birth associated with the XR user, and nationality associated with the XR user. The user identifier configured to facilitate authenticating and authorization of the XR user may be associated with a security policy. The security policy may comprise the authorization policy and the access control policy specifying the type of access control and the information a requestor has access to.

The method may further comprise receiving a response comprising a status of the request and stored information associated with the digital avatar of the XR user. The response may be received from the XR server. The stored information may comprise at least an avatar identifier associated with the digital avatar of the XR user. The stored information associated with the digital avatar of the XR user may be stored on an external XR storage server associated with the XR server.

The method may further comprise causing creation of the digital avatar of the XR user. The creation of the digital avatar of the XR user may be conducted by a rendering engine based on the user identifier and the one or more of the other user information, the avatar name, the avatar description, the information and associated metadata associated with creating the digital avatar of the XR user, the authorization policy, the access control policy, the avatar status, the multi-factor authentication (MFA) level, the verification interval, the discoverable indicator, the discoverable level, the certification resource, the location, the schedule, the avatar source information, the family list, the friends list, or the XR service providers list. The rendering engine may output well-defined and formatted data associated with the rendering of the digital avatar of the XR user. The causing creation of the digital avatar of the XR user may be further based on a determination that the one or more application clients are authorized to request creation of the digital avatar of the XR user. This determination may be based on the user identifier.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to features that solve any or all disadvantages noted in any part of this disclosure.

### BRIEF DESCRIPTION OF THE DRAWINGS

A more detailed understanding may be had from the following description, given by way of example in conjunction with the accompanying drawings.

FIG. 1 shows an example of an application layer architecture model;

FIG. 2 shows an example of client-initiated digital avatar creation;

FIG. 3 shows an example of server-initiated digital avatar creation;

FIG. 4 shows an example of a digital avatar retrieval;

FIG. 5 shows an example of digital avatar modification;

FIG. 6 shows an example of digital avatar deletion;

FIG. 7 shows an example of digital avatar subscription/notification;

FIG. 8 shows an example use of digital avatar certification;

FIG. 9 shows an example of digital avatar discovery;

FIG. 10 shows an example 3GPP avatar certification method;

FIG. 11 shows an example GUI to create an avatar;

FIG. 12 shows an example digital avatar resource tree;

FIG. 13A illustrates an example communications system;

FIGS. 13B, 13C, and 13D are system diagrams of example RANs and core networks;

FIG. 13E illustrates another example communications system;

FIG. 13F is a block diagram of an example apparatus or device, such as a WTRU; and

FIG. 13G is a block diagram of an exemplary computing system.

### DETAILED DESCRIPTION

As used herein, the following acronyms may have the following meanings:

| | |
|---|---|
| 3GPP | Third Generation Partnership Project |
| API | Application Programming Interface |
| AR | Augmented Reality |
| DNS | Domain Name System |
| FQDN | Fully Qualified Domain Name |
| GUI | Graphical User Interface |
| IE | Informational Element |
| IoT | Internet of Things |
| IP | Internet Protocol |
| MFA | Multi-Factor Authentication |
| MNO | Mobile Network Operator |
| PDU | Protocol Data Unit |
| REST | Representational State Transfer |
| SEALDD | Service Enabler Architecture Layer Data |
| | Delivery |
| UE | User Equipment |
| URL | Uniform Resource Locator |
| URSP | UE Route Selection Policy |
| VR | Virtual Reality |
| XR | eXtended Reality |
| XRMAPP | eXtended Reality and Media services |
| | Application enabler layer |

As used herein, the following terms may have the following meanings:

| | |
|---|---|
| Digital avatar or avatar | Information of an XR user's expressions and |
| | movements that are rendered in XR services. |
| | In addition, an avatar may contain |
| | information about an XR user that may be |
| | used to certify and discover the XR user. |
| | Avatars may also represent rendered virtual |
| | persons and their expressions and movements. |
| XR user | A user apparatus (e.g., computer, smart |
| | phone, tablet) hosting compute, memory and |
| | network connectivity resources capable of |
| | hosting a user application software (e.g., web |
| | browser, application client) which a user uses |
| | to participate in XR services. |

### Application Layer Architecture

In some aspects, mechanisms may allow users and/or XR service providers to certify an XR user's avatar and/or to identify the actual user of the avatar. Because XR services may be wide ranging with many service providers offering XR services to a multitude of users, these services may allow an XR user to discover other XR users actively participating in XR services, with various XR service providers, and between different platforms.

Some aspects may be relevant to one or more systems, including 3GPP systems, 5G systems, cellular systems, and/or cloud service provider platforms. Relevant nodes may include one or more of XR application client/server(s), XR storage server(s), SEALDD client(s)/server(s), SEALDD storage server(s), application or VAL client(s)/server(s), User Equipment (UE), Core Network (CN), Application Function (AF), and/or cloud server(s).

Relevant layer(s) may include one or more of 3GPP protocol stacks, XRM application enabler layer, SEALDD enabler layer, service layer, application enabler or VAL layers. Relevant standards may include one or more of 3GPP SA6 and/or non-standard XR services.

An XR client may receive a message from one or more application clients. The message may include information that may be used to create an XR user's digital avatar. Moreover, the information may include one or more of an image, a video, a location, an audio recording, and/or one or more sensor measurements. The XR client may send a request to an XR server to create the XR user's digital avatar. The request may include one or more of a user identifier, user information, an avatar name and description, and/or information with associated meta-data to create the XR user's digital avatar. The XR client may receive a response from the XR server. The response may include a status for the request and/or the information saved for the XR user's digital avatar. The information saved for the XR user's digital avatar may include one or more of a user identifier, user information, an authorization policy, an access control policy, an avatar identifier, an avatar name, an avatar description, an avatar status, an MFA level, a verification interval, a discoverable indicator and level, a certification resource, a location, a [7] schedule, avatar source information, a family list, a friends list, and/or an XR service providers list. The avatar source information may include one or more of a type, meta-data, rendering engine, and/or data for rendering the avatar.

An XR server may receive requests from one or more XR clients. The requests may include one or more of a user identifier, user information, an avatar name and description, and/or information with associated meta-data to create an XR user's digital avatar. The information to create the XR user's digital avatar may include one or more of an image, a video, a location, an audio recording, and/or one or more sensor measurements. The XR server may perform authentication and authorization of the one or more XR clients to ensure the clients are authorized to provide information for the creation of the XR user's digital avatar. The XR server may assign an avatar identifier for the XR user's digital avatar. The XR server may aggregate and apply the information and associated meta-data to create the XR user's digital avatar with a rendering engine. The rendering engine may output well-formatted data for rendering the XR user's digital avatar. The XR server may store the data for the XR user's digital avatar in a local or remote repository. The XR server may send one or more responses to the XR clients. The response may include a status for the one or more requests and the data saved for the digital avatar.

The XR server may receive a request from an application server to certify an XR user's digital avatar. The request may include one or more of a user identifier, user information, an avatar identifier, avatar source information, a certification indicator, an MFA level, and/or an identifier of the requestor. The XR server may check the requestor is authorized to request the certification of the XR user's digital avatar associated with the user identifier and/or avatar identifier. The XR server may send a request to an XR storage server. The request may include at least one of a user identifier, user information, an avatar identifier, avatar source information, a certification indicator, an MFA level, verification interval, and/or an identifier of the requestor. The XR server may receive a response from the XR storage server. The response may include certification information. The XR server may send a response to the application server. The response may include information to certify the user identifier and/or avatar identifier and the avatar source for the application server to render the avatar in XR services. The avatar source may include one or more of the type of avatar, meta-data for the avatar, information on a rendering engine, and data to render the avatar for XR services.

An XR client may receive a request from an XR server to certify an XR user's digital avatar. The request may include at least one of a certification type, the identifier of the requestor, and/or the avatar identifier to certify. The certification type may be information required to certify the avatar and may include at least one of an image, a video, a location, an audio recording, and one or more sensor measurements. The XR server may send one or more requests to client applications for certification information of the XR user's digital avatar. The XR server may collect certification information from the one or more client applications. The XR server may send a response to the XR server. The response may include the certification information received from the one or more client applications.

An XR client may receive a first request from an application client. The first request may include one or more of an avatar identifier, an avatar name, an avatar description, and/or a discovery token associated with an XR user's digital avatar. The request may discover the XR user's digital avatar. The XR client may send a second request to an XR server. The second request may include one or more of an avatar identifier, an avatar name, an avatar description, and/or a discovery token for discovering the XR user's digital avatar. Moreover, the second request may include a user identifier, the avatar identifier of the XR user, and an indication for avatar discovery. The XR client may receive a response to the second request. The response may include a status to the second request, an avatar identifier, avatar name, avatar status, and/or information about the avatar source. Moreover, the response may include pending access control information. The XR client may send a response to the first request. The response to the first request may indicate whether any digital avatars of XR users were found and/or the information received in the response to the second request.

An XR server may receive a first request from an XR client. The first request may include one or more of an avatar identifier, an avatar name, an avatar description, and/or a discovery token associated with an XR user's digital avatar. The request may be to discover the status of the digital avatar. The XR server may perform a search to find one or more matches for an avatar identifier, avatar name, and/or avatar description from a local repository. The XR server may find one or more avatar identifiers matching the search criteria. The XR server may send one or more requests to one or more storage servers where the XR user's digital avatars are stored. The one or more requests may include at least one of an identifier of the requestor, avatar identifier, avatar name, avatar description, and/or discovery token. The XR server may receive responses to the one or more requests. The responses may include one or more of a status of the request, an avatar identifier, an avatar name, an avatar status, and/or information about the avatar source. Moreover, the response may include pending access control information. The XR server may send a response to the first request, the response may indicate whether any digital avatars of XR users were found and/or the information received in the response to the one or more requests.

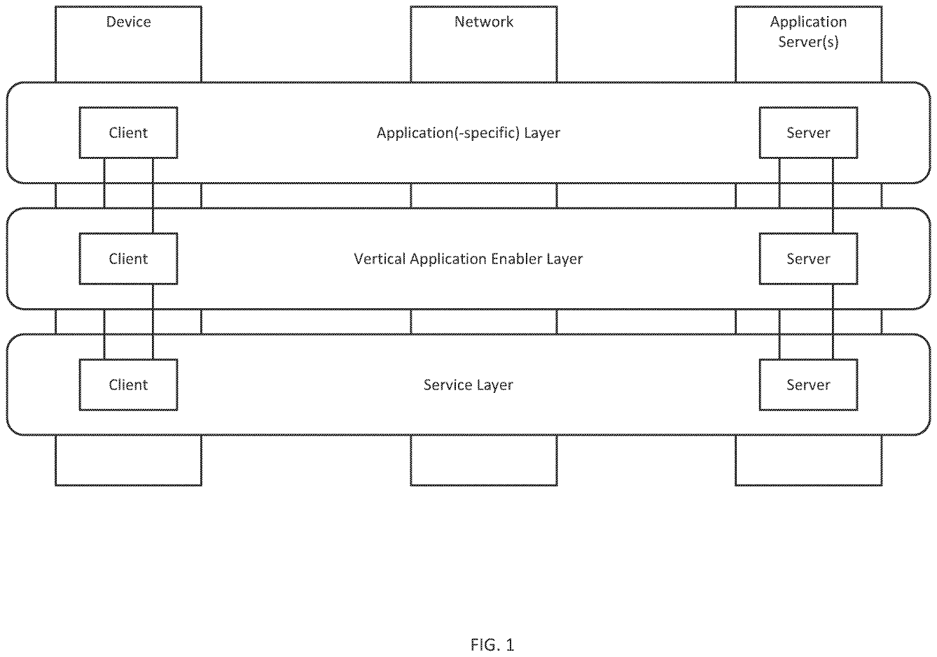

FIG. 1 shows a generalized application layer architecture that divides application logic into three distinct layers: application-specific, vertical application enabler, and the service layers. At the bottom of the application stack is the service layer, which provides common services to all applications. The services may include location, group management, configuration management, and security aspects for application development. Above the service layer is the vertical application enabler layer, e.g., the layer that manages services for a specific vertical application such as autonomous vehicles, drones, IoT, gaming, etc. At the top of the application stack is the application-specific layer which serves specific applications within a vertical application. This layer contains custom or business logic for a particular application and may be provided by various service providers in a vertical application. The goal of this three-layered approach is to abstract common services for all applications to the vertical application enabler and service layers to simplify application development for faster deployments of the applications.

The architecture shown in FIG. 1 is based on the client-server communication model. One or more client applications on a device may communicate with one or more server applications on application servers. Note that the server applications may reside in one or more application servers. Client application and server application of each layer communicate with each other between the device and the application server. The application-specific client and server may communicate with the client and server at the service layer, respectively. In that scenario, the services provided by the vertical application enabler layer may be integrated into the service layer. A network between the client and server applications provides the medium for communication. The network may be a cellular network such as a mobile operator network or the network may be some broadband service provider network providing access to the internet. It is also worth noting, that for decentralized deployments in which devices communicate directly with other devices, server functionality may reside on a device rather than in the network. For this case, devices may communicate with one another such that one device may function as a client and another device may function as a server.

### XR Digital Avatar Creation

Prior to an XR user's participation in XR services, an XR user may need to create a digital avatar to represent the user in the XR service. The avatar may represent the actual likeness of the XR user and/or the XR user may select a similar likeness but with different characteristics (e.g., hair style, hair/eye/skin color, face shape, unique facial features such as larger eyes/nose/ears, dimples, freckles, etc.). An XR user's physical dimensions may also be captured, such as height, weight, arm size and length, leg length, bodily proportions, etc. Depending on the avatar generator, an XR user may need to provide the associated features for the digital avatar either through an image or video, information input by the XR user, data from wearable sensors, and/or other scanning/sensing devices. As a result, information about the XR user may be captured from multiple sources in order to generate the XR user's digital avatar.

For example, a method for use by an extended reality client may comprise receiving a message comprising information associated with creating a digital avatar of an XR user. The message may be received from one or more application clients or application servers. The digital avatar may comprise a medium for the XR user to interact with one or more other XR users in or more XR services. Each of the one or more application clients or application servers may be associated with a separate device. The separate device may be one of a smartphone, an external camera, or a wearable sensor device.

The method may further comprise sending a request to create the digital avatar of the XR user. The request may be sent to an XR server. The request may comprise a user identifier configured to facilitate authenticating and authorization of the XR user, and one or more of other user information, an avatar name, an avatar description, information and associated metadata associated with creating the digital avatar of the XR user, an authorization policy, an access control policy, an avatar status, a multi-factor authentication (MFA) level, a verification interval, a discoverable indicator, a discoverable level, a certification resource, a location, a schedule, avatar source information, a family list, a friends list, or an XR service providers list, wherein the avatar source information comprises one or more of a type, metadata, a rendering engine, or avatar data for rendering. The information and associated metadata associated with creating the digital avatar of the XR user may comprise one or more of an image, a video, a location, an audio recording, and one or more sensor measurements. One or more other users identified in one of the family list, the friends list, or the XR service provider list may have access to the avatar of the XR user. The other user information may comprise one or more of a name associated with the XR user, an address associated with the XR user, height associated with the XR user, weight associated with the XR user, date of birth associated with the XR user, and nationality associated with the XR user. The user identifier configured to facilitate authenticating and authorization of the XR user may be associated with a security policy. The security policy may comprise the authorization policy and the access control policy specifying the type of access control and the information a requestor has access to.

The method may further comprise receiving a response comprising a status of the request and stored information associated with the digital avatar of the XR user. The response may be received from the XR server. The stored information may comprise at least an avatar identifier associated with the digital avatar of the XR user. The stored information associated with the digital avatar of the XR user may be stored on an external XR storage server associated with the XR server.

The method may further comprise causing creation of the digital avatar of the XR user. The creation of the digital avatar of the XR user may be conducted by a rendering engine based on the user identifier and the one or more of the other user information, the avatar name, the avatar description, the information and associated metadata associated with creating the digital avatar of the XR user, the authorization policy, the access control policy, the avatar status, the multi-factor authentication (MFA) level, the verification interval, the discoverable indicator, the discoverable level, the certification resource, the location, the schedule, the avatar source information, the family list, the friends list, or the XR service providers list. The rendering engine may output well-defined and formatted data associated with the rendering of the digital avatar of the XR user. The causing creation of the digital avatar of the XR user may be further based on a determination that the one or more application clients are authorized to request creation of the digital avatar of the XR user. This determination may be based on the user identifier.

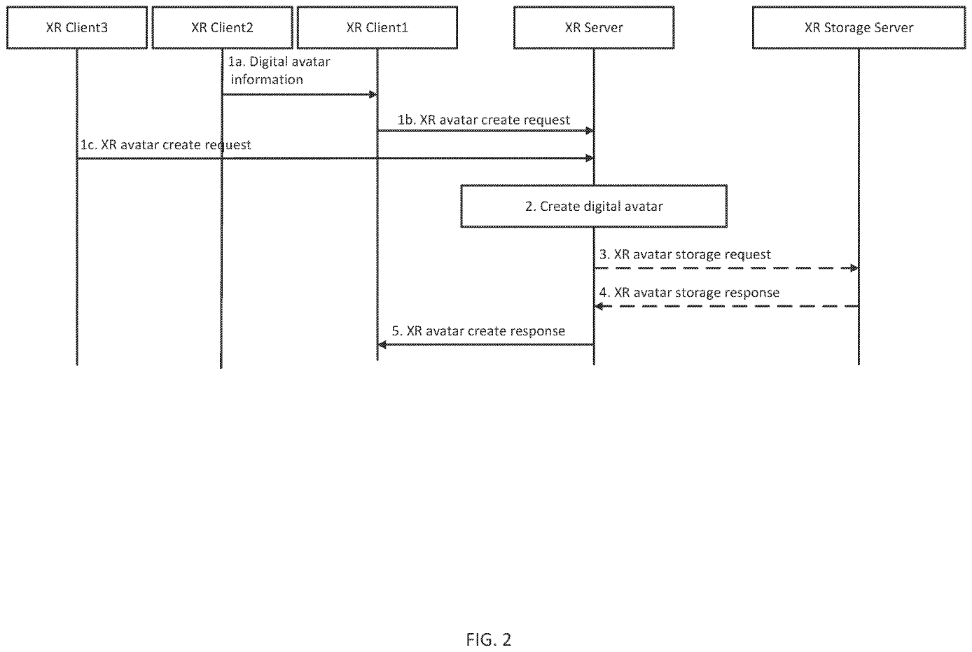

FIG. 2 shows an example method where three different sources of information are provided to an XR server to create an XR user's digital avatar. Each source of information may be associated with an XR application client, and each application client may be running on separate devices. For example, one client may run on a smartphone, another client may run on an external camera, and a third client may be a wearable sensor device. The XR user may use XR client1 to communicate with the XR service provider represented by the XR server in FIG. 2. The XR service provider may offer the XR user the ability to create a digital avatar among other services the XR service provider may offer. In some aspects, the XR service provider and the digital avatar service provider may be different. The XR server may interface to an external XR storage server to store the data required to render the XR user's digital avatar or the storage of an XR user's digital avatar may be local within the XR server.

FIG. 2 shows an example of a cloud service provider (CSP) deployment in which XR users obtain XR services from the cloud service provider using XR clients. The XR server may be deployed as cloud servers operated by a CSP and the XR storage server may be external database servers or datacenters. The XR clients may be running on devices owned by the XR user, such as XR glasses, smartphones, cameras, haptic gloves and other wearable devices, and scanning/sensing devices.

As shown in FIG. 2, in step 1a, 1b, and 1c, three XR clients 1, 2, and 3 may provide information for generating a digital avatar for the XR user to an XR service provider (e.g., represented as the XR server in FIG. 2). The depiction of steps 1a, 1b, and 1c in FIG. 2 are for illustrative purposes to show one aspect of the method and not meant to be limiting in any way. Steps 1a, 1b, and 1c may be interchanged with each other and may be sent from any XR clients, such as XR client1, XR client2, and XR client3. For example, the XR user may operate XR client1, which may be running on a smartphone. A camera may operate XR client2 to provide the XR server images or videos of the XR user from different perspectives to assist with constructing the XR user's digital avatar. A third XR client3 may be associated with wearable sensors worn by the XR user that may provide sensor measurements about the XR user to the XR user's smartphone to send to the XR server. The wearable sensors may be a haptic glove and ankle sensor that may provide biometric and/or relative distance information to assist with determining the XR user's torso length or height. For example, the XR user may be prompted to put a hand wearing a haptic glove on their hip and/or their head to measure the XR user's legs and/or height, respectively, relative to the ankle sensor. Note that other clients may also be used to generate information about the XR user for digital avatar creation, such as XR glasses and scanning/sensing devices. Any of the XR clients may send information associated with the digital avatar to any of the other XR clients, as shown in step 1a. Any of the XR clients may send an XR avatar creation request, as shown in steps 1b and 1c.

The requests from the XR clients may include a user identifier that relates to the provided information to the XR user. The XR clients may have been configured by the XR user as part of the digital avatar creation process. The XR clients may all communicate directly to the XR user's smartphone and the XR client on the smartphone may aggregate the information together before sending the request to the XR server. The requests from the XR clients may include information such as those shown in Table 1. The information provided in Table 1 is an example of information that may be used for creating and managing digital avatars for an XR user and the information may be organized in a different manner than what is shown.

Certain information shown in Table 1 may be XR user centric and therefore may be provided by the XR user in the XR client1 request to the XR server. The XR user may access a GUI on the user's smartphone to provide information such as the avatar name, information about the user, a description for the avatar the user would like to expose for avatar discovery, and the discovery level for the avatar. The XR user may also specify authorization and access control information for avatar identifiers of family, friends, and XR service providers that the XR user may want to be able to discover and communicate with.

The XR clients may also include meta-data in the requests sent to the XR server to provide additional information to the XR server on how to interpret the data. The meta-data may include the data type that was provided, the perspective information associated with the data (e.g., frontal, side, back views), location information where the data was collected from (e.g., face, hand, leg), etc.

In step 2, the XR server may first perform authentication and authorization of the XR clients to ensure the clients are authorized to provide information for the XR user's digital avatar creation and may check for a user identifier in the requests to associate the information to an XR user. Once the clients have been authenticated and authorized, the XR server may aggregate the information received from the XR clients to associate the information to the XR user's digital avatar and assign an avatar identifier for the XR user. The XR server may apply the data to an avatar rendering engine to create the digital avatar for the XR user. The avatar rendering engine may output a well-defined and formatted data that may be used by XR service providers to render the digital avatar of the XR user.

In step 3, optionally, the XR server may utilize an XR storage server to store the formatted data of the XR user's digital avatar for future use. The XR server may send one or more of the formatted data; the assigned avatar identifier; the avatar name, type, and size; and/or information of a rendering engine that can process the formatted digital avatar data. The XR server may store the data for the XR user's digital avatar internally and steps 3 and 4 may be skipped.

In step 4, the XR storage server may return a response with a status for the request (e.g., pass or fail) and the contact information and an identifier (e.g., such as a URI) of where the XR user's digital avatar data may be stored. The contact information and identifier may be used to retrieve the digital avatar for use at a future time. The XR server may store the contact information and identifier within the Data storage IE that is shown in Table 1 and may provide the information to XR service providers to generate an XR user's avatar.

In step 5, the XR server may return a response to the XR client(s) with a status for the request and may include the contents of the digital avatar saved for the XR user as shown in Table 1.

TABLE 1
XR Digital Avatar Information

| Informational | |
|---|---|
| Element (IE) | Parameter Description |
| User identifier | A user identifier to associate the digital avatar |
| | with an XR user. The user identifier may be associated |
| | with an account the XR user has with a digital |
| | avatar service provider such as a login identifier |
| | in the case of a CSP or a user equipment identifier |
| | in the case of a mobile network operator. For cases |
| | in which multiple devices are providing information |
| | about an XR user for avatar creation, the XR clients |
| | may be configured to include the user identifier in |
| | the requests to identify the information is associated |
| | with a particular XR user. |
| User | Information about the XR user such as name and |
| information | address. Additional information about the XR user |
| | may also be provided: height, weight, date of |
| | birth, nationality, etc. The user information IE |
| | may be used to certify the XR user and/or the XR |
| | user's digital avatar. |
| XR client | Information about each XR client contributing |
| information | information to the digital avatar of the XR user. |
| | Information regarding each XR client may comprise an |
| | identifier of the XR client, network address of the |
| | XR client, application clients associated with the XR |
| | client, and the information the XR client may provide. |
| | A token may also be provided to authenticate the XR |
| | client with the XR digital avatar service provider. |
| Authorization | An authorization policy may be specified to indicate |
| policy | exposure of the information associated with a digital |
| | avatar to a third-party, which may consist of XR |
| | service providers and other XR users. The |
| | authorization policy may have temporal or spatial |
| | constraints for accessing the information in the |
| | digital avatar. An XR user may provide a discovery |
| | token to other XR users that may enable temporary |
| | authorization for the other XR user to access |
| | information in the digital avatar. The discovery |
| | token may include the identifier and/or contact |
| | information of an XR server where to access the |
| | digital avatar. |
| Access control | An access control policy may be specified to provide |
| policy | full or limited access to information associated with |
| | the digital avatar. Access control may be read, write, |
| | validate, execute, delete, subscription, etc. Validate |
| | may be accesses that require the XR server to validate |
| | for a requestor without disclosing the actual |
| | information to the requestor. Execute may be |
| | accesses to render the digital avatar using the |
| | rendering engine. |
| Avatar | An identifier for an XR user's digital avatar. The |
| identifier | identifier may also include information to identify |
| | the XR digital avatar provider, e.g., an XR server. |
| | The XR user may have multiple digital avatars and |
| | hence multiple avatar identifiers. |
| >Avatar name | The name provided for the digital avatar that is |
| | exposed to other XR users and may be use for |
| | discovery purposes. |
| >Avatar | Human readable description for the avatar the XR user |
| description | may want to expose to other XR users and/or XR |
| | service providers and may be use for discovery |
| | purposes. |
| >Status | The status of the digital avatar: online, offline, do |
| | not disturb, etc. The status IE may also include |
| | information about the XR service that the avatar is |
| | participating in. |
| >MFA level | The multi-factor authentication level associated with |
| | the digital avatar. Each level may specify the |
| | certification type and how many sources are verified, |
| | e.g., a level of three may require three sources |
| | of verification. The verification sources may be |
| | clients that can provide information (i.e. |
| | certification type) to certify the XR user: an |
| | identifier, an image or video of the XR user's |
| | face captured by a camera on an XR headset and/or |
| | external camera, measurements from certain wearables |
| | and/or sensors, location information, etc. Biometric |
| | information such as information received from retina |
| | and fingerprint scanners may also be used as |
| | verification sources. Voice recognition and/or voice |
| | recordings with a spoken passphrase may also be used |
| | as verification sources. Information about the source |
| | may be included for an XR server to contact for |
| | verification. |
| >Verification | A verification interval may be specified to trigger |
| interval | the (re-) verification of the XR user's digital |
| | avatar after authentication has completed. The interval |
| | may be specified for scenarios where an XR service |
| | may require periodic verification of the XR user to |
| | ensure the XR user is still controlling the digital |
| | avatar. An example may be an XR service providing |
| | monitoring services of XR users taking examinations |
| | in an academic or professional setting. The XR |
| | service may need to periodically verify the XR |
| | user is taking the exam and not some other user. |
| | Another example may be remote monitoring of chess |
| | players in a tournament to help circumvent cheating. |
| >Discoverable | An indicator of whether the digital avatar is |
| | discoverable by other XR users and/or XR service |
| | providers. There may be various discoverable levels: |
| | family, friends, XR service providers, other XR users. |
| | A schedule may also be associated with the indicator |
| | to show when the avatar can be discovered. |
| >Certification | A resource that may show whether the digital avatar |
| | has been certified and may include the certification |
| | entity/authority and the XR service provider or XR |
| | user that the certification applies to. Certification |
| | may refer to the process that the XR server validates |
| | to a third-party consumer such as an XR service |
| | provider or other XR users that the digital avatar |
| | is associated with the XR user. An expiration may be |
| | associated with the certification. |
| >Location | The location that is associated with the avatar, |
| | which can be a physical or virtual location. There |
| | may be options for tracking the avatar, which may |
| | require reporting periodic or event-based location |
| | information. |
| >Schedule | A schedule may be associated with the avatar for |
| | the times it is available. The schedule may also |
| | apply to the times the avatar is discoverable. |
| >Avatar source | The source of information to generate an XR user's |
| | digital avatar. An identifier may include information |
| | for where the avatar source can be found, e.g., an XR |
| | server or an XR storage server. |
| >>Type | The type of digital avatar: 3D, pseudo 3D, animated |
| | 2D, static 2D |
| >>Meta-data | The meta-data associated with the avatar may be used |
| | to describe how to render the avatar such as the |
| | dimensions to render the avatar for the XR user. |
| | The size of the avatar may correspond with the |
| | actual physical measurements of an XR user (e.g., |
| | height, weight, etc.) for the purpose of purchasing |
| | clothes and other articles of clothing or it may |
| | depict arbitrary dimensions of the avatar unrelated |
| | to the XR user's physical measurements, e.g., at |
| | the choosing of the XR user or to conform to the |
| | size requirements of an XR service. Other meta-data |
| | about the avatar may also be included: only facial |
| | view, half body view, entire body view, etc. |
| >>Rendering | For avatar source type other than static 2D, the |
| Engine | specification of an XR computing engine to render the |
| | avatar in 3D or to animate the avatar in 2D. A link |
| | (e.g., URL) may be provided to specify where to |
| | access the rendering engine, which may be provided |
| | by another service, or an identifier may be used to |
| | specify the rendering engine. Additionally, and/or |
| | alternatively, the rendering engine may be stored |
| | locally as executable functions such as provided by |
| | some avatar framework and/or ML model. |
| >>Avatar | The data to render an XR user's avatar that may |
| (static) data | include the data type and the actual data. If a |
| | rendering engine is specified, the data may be in a |
| | format that is required by the rendering engine to |
| | render the XR user's avatar in 3D or to add |
| | animation to a 2D avatar. For static 2D avatar, |
| | the data may be associated with an image or some |
| | equivalent form of visual information. The data may |
| | be separated into components showing different |
| | views or perspective of the XR user, e.g., front, |
| | side, back, angled view of the XR user and may |
| | incorporate physical characteristics and virtual |
| | clothes for the digital avatar. For example, |
| | information about the hair style, facial features, |
| | clothing, and accessories (such as hats, earrings, |
| | purses, tattoos, etc.) that may be needed to render |
| | the digital avatar. An identifier may be used to |
| | identify where the data for the avatar is stored |
| | if using an external storage server. The identifier |
| | may incorporate contact information of an external |
| | storage server where data to render the avatar is |
| | stored. |
| >>Dynamic | Dynamic data may be used to provide tracking data |
| data | for rendering gestures and movements of the digital |
| | avatar. Sources providing the dynamic data may be |
| | specified to provide the dynamic data. Additionally, |
| | and/or alternatively, a ML model may be specified to |
| | provide the dynamic data based on inputs received |
| | from the XR environment. |
| Family list | A list that contains digital avatars of XR users |
| | that may be part of the XR user's family. |
| >Avatar ID | The identifier to a digital avatar. The identifier |
| | may also be used to identify the XR service provider |
| >>Avatar name | The name provided for the digital avatar that is |
| | exposed to other XR users. |
| >>About | Human readable description about the XR user |
| | associated with the digital avatar. |
| >>Certification | An indicator that shows whether the digital avatar |
| | has been certified. An expiration may be associated |
| | with the certification. |
| Friends list | A list that contains digital avatars of friends |
| | the XR user communicates with |
| >Avatar ID | The identifier of a digital avatar. The identifier |
| | may also be used to identify the XR service provider |
| >>Avatar name | The name provided for the digital avatar that is |
| | exposed to other XR users. |
| >>About | Human readable description about the XR user |
| | associated with the digital avatar. |
| >>Certification | An indicator that shows whether the digital avatar |
| | has been certified. An expiration may be associated |
| | with the certification. |
| XR service | A list of XR service providers the XR user may have |
| provider list | an existing relationship with |
| >XR service | The name of the XR service provider. |
| provider name | |
| >Contact | Contact information for the XR service provider, such |
| information | as FQDN, DNS name, IP address and port number, |
| | etc. |
| >>Avatar ID | The identifier to an avatar associated with the XR |
| | service provider. For example, a bank may offer |
| | personalize services to XR users and have multiple |
| | employees that have interactions with the XR user, |
| | e.g., a customer service representative, a loan |
| | officer, a service manager. |
| >>>Avatar name | The name provided for the digital avatar that is |
| | exposed to other XR users. |
| >>>About | Human readable description about the XR user |
| | associated with the digital avatar. |
| >>>Certification | An indicator that shows whether the digital avatar |
| | has been certified. An expiration may be associated |
| | with the certification. |

The information shown in Table 1 may be saved in a RESTful resource structure, database, and/or context information within a digital avatar service provider domain. The information may be organized differently than what is shown in Table 1. For example, the avatar source information may be stored in a digital avatar repository (e.g., XR storage server) separate from other information listed in Table 1.

A user identifier may be provided and/or assigned during the creation of the digital avatar. The user identifier may be associated with an account the XR user has with the digital avatar service provider such as a login identifier in the case of a CSP deployment or a user equipment identifier in the case of a mobile network operator deployment. Associated with the user identifier may be user information that identifies the XR user, such as name and address. Other user information may include height, weight, date of birth, and nationality. The user information may be used as part of avatar certification.

Authorization and access control policies may be specified to secure access to information in the digital avatar. The authorization policy may include an identifier of the requestor with granted access and an expiration for the authorization. A requestor may be XR service providers or other XR users. The access control policy may specify what information the requestor may have access to and the type of access control, e.g., read, write, validate, execute, and delete. The access control policy may be linked with the authorization policy and thus, the policies may be combined together to form a security policy for the digital avatar.

An XR user may have one or more digital avatars for participation in XR services: one for professional use, one for personal use, and a third for other purposes such as an online influencer. An online influencer may be used to gather online followers about a certain topic the XR user may be passionate about. Each digital avatar may have an associated identifier, name, and a description about the avatar. For example, the online influencer avatar may specify what topic (e.g., climate change, market research, product reviews, financial products, autonomous technologies) the XR user may be passionate about. There may be a status indicator showing the presence of the avatar in XR services, which may include information about the XR service provider the avatar is participating in. The information may be used for avatar discovery.

Certain XR services may require more robust authentication and verification of the XR user and may have stricter certification requirements to use the XR service. An example may be an XR service hosting examination services in academic or professional settings. The XR service provider may require multi-factor authentication of the XR user as well as periodic verification, which may be specified as MFA level and verification interval, respectively. The MFA level may specify which certification type and the sources of authentication are required. The verification interval may specify how often to verify the XR user after authentication. In the examination services example, the XR service provider may initially require multiple authentication sources, e.g., avatar identifier, location information retrieved from a device, facial recognition information from a camera, and audio capture of an XR user's voice with a spoken passphrase. Moreover, the verification interval may specify continuous video capture from an external camera capturing the XR user's environment during the examination and/or periodic reporting of the XR user's location. The XR service provider may require the verification interval to ensure the XR user is the person actually taking the exam.

For each avatar, informational elements may be specified to simplify access to information in the digital avatar. A Discoverable indicator may be provided to inform XR servers whether the avatar can be discovered by other XR users and/or service providers. A Certification resource may be used to list all XR service providers and other XR users that the digital avatar has been certified with. An XR server may update this list upon the completion of an avatar certification step and an expiration may be associated with the certification. The XR server may check the certification list to bypass the authentication step for the XR user or service provider at a future time. A location IE and a schedule IE may also be associated with the avatar. The location may represent a physical or virtual location for which the avatar is present, and the schedule may limit the times that the avatar may be used and/or discovered, e.g., as part of parental control for a child user.

The Avatar source resource may be specified to provide XR service providers and/or XR users with information to render the XR user's digital avatar. The resource may specify the type of digital avatar that may be displayed, meta-data on how to render the digital avatar, and the rendering engine to reproduce the avatar for display. The Avatar data may consist of both static and dynamic data that may be provided for the rendering engine to reproduce the avatar for display, including information that may be used to generate animations and/or avatar movements. Devices such as smartphones, cameras, and other wearable devices may provide the dynamic data for generating avatar gestures and movements. These devices may be used in real time to provide data for tracking gestures and movements of the XR user to render the gestures and movements by the avatar. A ML model may be specified to render gestures and movements of the avatar independent of other devices.

Within the digital avatar resource or context information, three lists may be maintained to assist the owner of the digital avatar with managing avatars of other XR users or XR users affiliated with one or more XR service providers. The lists, namely Family, Friends, and XR service providers, may be used to organize avatars that the owner may want convenient access to. The avatar information from the lists may contain basic information about the XR user and be certified for quicker access.

An application server may request to create a digital avatar for an XR user. The application server may be providing the XR service that the XR user is interested in and, as a requirement for using the XR service, the XR user may be required to be represented digitally within the XR service (e.g., with a digital avatar). The XR user may have a subscription with the XR service provider and may have authorized the XR service provider to request the creation of the digital avatar on behalf of the XR user.

An example method implemented by an extended reality server may comprise receiving one or more requests to create a digital avatar of an XR user. The one or more requests may be received from one or more XR clients. The digital avatar may comprise a medium for the XR user to interact with one or more other XR users in or more XR services. Each of the one or more XR clients may be associated with a separate device. The separate device may be one of a smartphone, an external camera, or a wearable sensor device. The one or more requests may comprise a user identifier configured to facilitate authenticating and authorization of the XR user, and one or more of other user information, an avatar name, an avatar description, information and associated metadata associated with creating the digital avatar of the XR user, an authorization policy, an access control policy, an avatar status, a multi-factor authentication (MFA) level, a verification interval, a discoverable indicator, a discoverable level, a certification resource, a location, a schedule, avatar source information, a family list, a friends list, or an XR service providers list, wherein the avatar source information comprises one or more of a type, metadata, a rendering engine, or avatar data for rendering.

The information and associated metadata associated with creating the digital avatar of the XR user may comprise one or more of an image, a video, a location, an audio recording, and one or more sensor measurements. One or more other users identified in one of the family list, the friends list, or the XR service provider list may have access to the avatar of the XR user. The other user information may comprise one or more of a name associated with the XR user, an address associated with the XR user, height associated with the XR user, weight associated with the XR user, date of birth associated with the XR user, and nationality associated with the XR user. The user identifier configured to facilitate authenticating and authorization of the XR user may be associated with a security policy. The security policy may comprise the authorization policy and the access control policy specifying the type of access control and the information a requestor has access to.

The method may further comprise determining that the one or more XR clients are authorized to request creation of the digital avatar. This determination may be based on the user identifier.

The method may further comprise assigning an avatar identifier for the digital avatar of the XR user.

The method may further comprise storing the avatar identifier and well-defined and formatted data associated with rendering the digital avatar of the XR user.

The method may further comprise sending one or more responses to the XR clients. The one or more response may comprise a status of the one or more requests and stored information. The store information may be associated with the digital avatar of the XR user. The stored information may comprise at least an avatar identifier associated with the digital avatar of the XR user. The stored information associated with the digital avatar of the XR user may be stored on an external XR storage server associated with the XR server.

The method may further comprise causing creation of the digital avatar of the XR user. The creation of the digital avatar of the XR user may be conducted by a rendering engine based on the user identifier and the one or more of the other user information, the avatar name, the avatar description, the information and associated metadata associated with creating the digital avatar of the XR user, the authorization policy, the access control policy, the avatar status, the multi-factor authentication (MFA) level, the verification interval, the discoverable indicator, the discoverable level, the certification resource, the location, the schedule, the avatar source information, the family list, the friends list, or the XR service providers list. The rendering engine may output well-defined and formatted data associated with the rendering of the digital avatar of the XR user. The causing creation of the digital avatar of the XR user may be further based on a determination that the one or more application clients are authorized to request creation of the digital avatar of the XR user. This determination may be based on the user identifier.

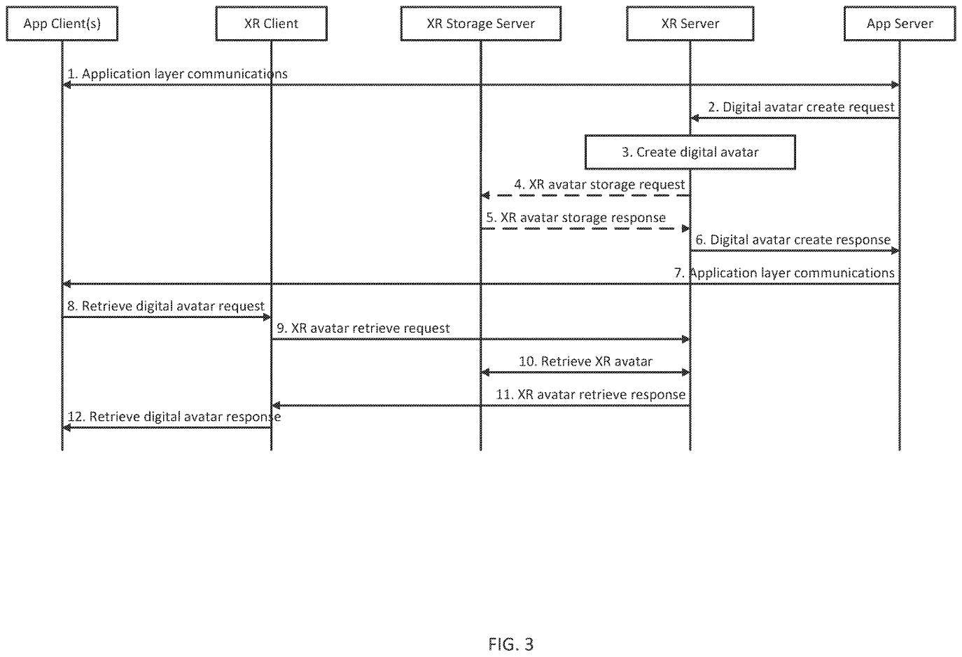

FIG. 3 shows an example of such a scenario where an application server may request to create a digital avatar for the XR user. FIG. 3 shows both application client/server as well as XR client/server in addition to an XR storage server. The application client may be used by the XR user to access the XR services provided by the XR service provider (e.g., represented as the application server). The XR client/server may be the vertical application enabler client/server referred to in FIG. 1, which may provide the vertical application specific services available to all XR applications. In this scenario, the vertical application enabler client/server may provide the service for the creation of digital avatars associated with XR users. For example, an architecture may include deployments of mobile network operators (e.g., 3GPP networks). The MNO may provide digital avatar management services (e.g., by the XR client and server) to third-party XR service providers such as application clients and servers. The XR storage server may be represented as SEALDD storage servers that the MNO or a third-party application function may operate and manage. The SEALDD storage servers may provide horizontal services to which all applications may have access (e.g., functionalities provided by the service layer as shown in FIG. 1).

As show in FIG. 3, in step 1, an application client may communicate with an application server for XR services. The XR user using the application client may have a subscription with the XR service provider operating the application server. For example, the XR user may have subscribed to a gaming service provided by the XR service provider. As part of using XR services, the XR service provider may require the XR user to establish a digital avatar. The XR user may be using XR glasses and other wearable devices that may provide information to the application server to assist with creating the digital avatar for the XR user. There may be multiple sources of information provided for the creation of the digital avatar. The multiple sources may provide the same user identifier in the requests to inform the application server the data is related to the XR user and the XR user's digital avatar.

In step 2, using information provided by the XR user through the application client(s), the application server may send a request to an XR server that can create a digital avatar for the XR user. The application server may discover the XR server, or the application server may have been provisioned with contact information about the XR server through pre-configured or local policies. Moreover, the XR user may provide the information about the XR server to the application server. The application server may include in the request one or more of the application server identifier, an indicator to create a digital avatar, a user identifier, the information for creating the digital avatar, an identifier for an avatar rendering engine, and other information from Table 1 that may have been provided by the application clients.

In step 3, the XR server may first perform authentication and authorization of the application server and, if authorized, the XR server may evaluate the data received for creating the digital avatar. The XR server may create an avatar resource to associate with the user identifier, assign an avatar identifier for the avatar, and apply the source data to the avatar rendering engine specified by the application server (e.g., if one was provided) to create the digital avatar for the XR user. In the case an avatar rendering engine was not provided, the XR server may use an avatar rendering engine of its choosing. The avatar rendering engine may output a well-defined and formatted data that may be used by the XR service provider to render the digital avatar for the XR user.

In step 4, the XR server may store the contents of the digital avatar in an external storage server, such as an XR storage server. The XR server may send one or more of the formatted data; the assigned avatar identifier; the avatar name, type, and size; and information of the rendering engine that can process the formatted digital avatar data.

In step 5, the XR storage server may return a response with a status for the request (e.g., pass or fail) and the contact information and an identifier (e.g., such as a URI) of where the digital avatar data is stored. The XR server may store the contact information and identifier within the Data storage IE that is shown in Table 1.

In step 6, the XR server may return a response to the application server with a status for the request and may include the contents of the digital avatar saved for the XR user (e.g., as shown in Table 1).

In step 7, using application layer communications, the application server may provide the application client information used to retrieve the digital avatar for the XR user. The information may include the contact information (e.g., FQDN, DNS name, IP address and port number) of the XR server, the application server identifier, the user identifier, and the avatar identifier. The XR server may inform the XR client that a digital avatar has been created for the XR user.

In step 8, the application client may make a request to retrieve the contents of the digital avatar for the user. The request may include the contact information of the XR server, the user identifier and/or the avatar identify.

In step 9, the XR client may perform a retrieve request to obtain the digital avatar of the XR user. The request may include the user identifier, the avatar identifier, and the application server identifier.

In step 10, the XR server may check authorization of the XR client and if authorized, the XR server may retrieve (e.g., from the XR storage server) the digital avatar of the XR user using the user identifier and/or avatar identifier. The XR server may also provide the application server identifier to indicator the digital avatar was created by the application server. The XR storage server may return a status for the request and the contents of the digital avatar of the XR user (e.g., as shown in Table 1).

In step 11, the XR server may return a response to the XR client. The response may include one or more of the statuses of the request and the content of the XR user's digital avatar as received from the XR storage server.

In step 12, the XR client may return the information received from the XR server to the application client, which may display the information to the XR user in a GUI.

Both CSP and MNO deployments are presented in FIG. 2 and FIG. 3, respectively. A difference between the CSP and MNO deployments may be the introduction of a vertical application enabler layer in the architecture (e.g., as shown in FIG. 1). Within this architecture, services may be divided into service, vertical application enabler, and application-specific layers. In CSP deployments, all the services may be combined together into one common application specific layer for XR communications (e.g., as shown in FIG. 1).

A benefit of having a multi-layer architecture (e.g., as shown in FIG. 1) is the ability to reuse common services that may be required for all (e.g., provided by the service layer) or similar (e.g., provided by the vertical application enabler layer) applications. In a CSP deployment, there may less of a requirement or no requirement to support multiple applications in different industries and the design of applications may only focus on the requirements of one industry. Hence, it may be that only an application-specific layer is required.

The following aspects may be illustrated for both CSP and MNO deployments. For CSP deployments, XR consumers and XR servers are highlighted and, for MNO deployments, the XR clients and XR servers may represent the vertical application enabler entities and the application clients and application servers may represent the application-specific entities. The illustrated methods may apply to either deployment scenarios.

An external storage server may exist to store the information contained in a digital avatar. The external storage server may not be included in one or more illustrations. This may be a deployment option and it may be implied that the storage is kept internally within the XR server, e.g., in a local database managed by the XR server. The external storage server may be an external database server and/or cluster, or simply an external application server that has the storage capability. For MNO deployments, the XR storage server may be a SEALDD storage server or some other application function dedicated to data storage.

### XR Digital Avatar Management Methods

Once a digital avatar is created for an XR user, any authorized consumer may access the digital avatar using the management methods described herein. A consumer may be an XR user using a client application, an XR client, or an XR service provider that is represented by an application server.

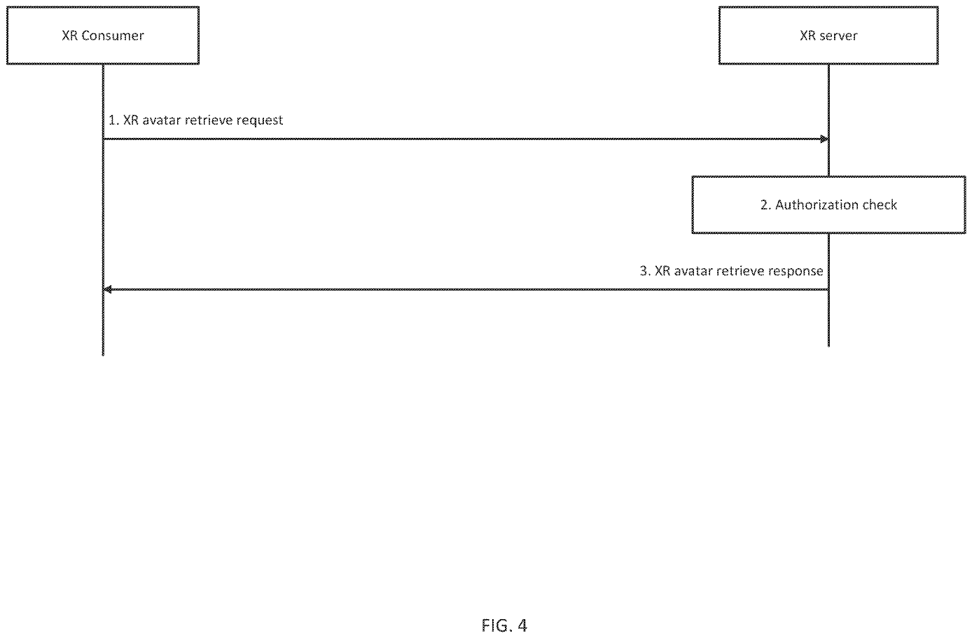

FIG. 4 shows an example method in which a consumer is making a retrieve request, to an XR server, for information in a digital avatar of an XR user. The retrieve request may request information from Table 1, e.g., provided the consumer is authorized and has access control privileges to information in the digital avatar.

As shown in FIG. 4, in step 1, a consumer may request to retrieve information from an XR user's digital avatar (e.g., such as the information listed in Table 1). The consumer may send a request to the XR server and in the request provide one or more of the user identifier associated with the digital avatar, the avatar identifier, an identifier of the consumer, and the requested information.

In step 2, the XR server may check the authorization and access control policies to determine whether the consumer is authorized to retrieve information from the digital avatar and whether access control is allowed for the requested resource.

In step 3, if the authorization and access control checks are successful, the XR server may return the requested information in a response sent to the consumer. The response may also contain the status for the retrieve request.

If a consumer is authorized and has access control, the consumer may also be able to modify information in a digital avatar (e.g., as shown in Table 1). For example, the consumer may be a family member or friends with the XR user and may want to share the consumer's avatar identifier with the XR user to participate in XR services together. The consumer may also be an XR service provider that the XR user has an existing relationship with and may want to be certified with the XR user's digital avatar for easier interaction with the XR user to provide the XR service provider's XR services.

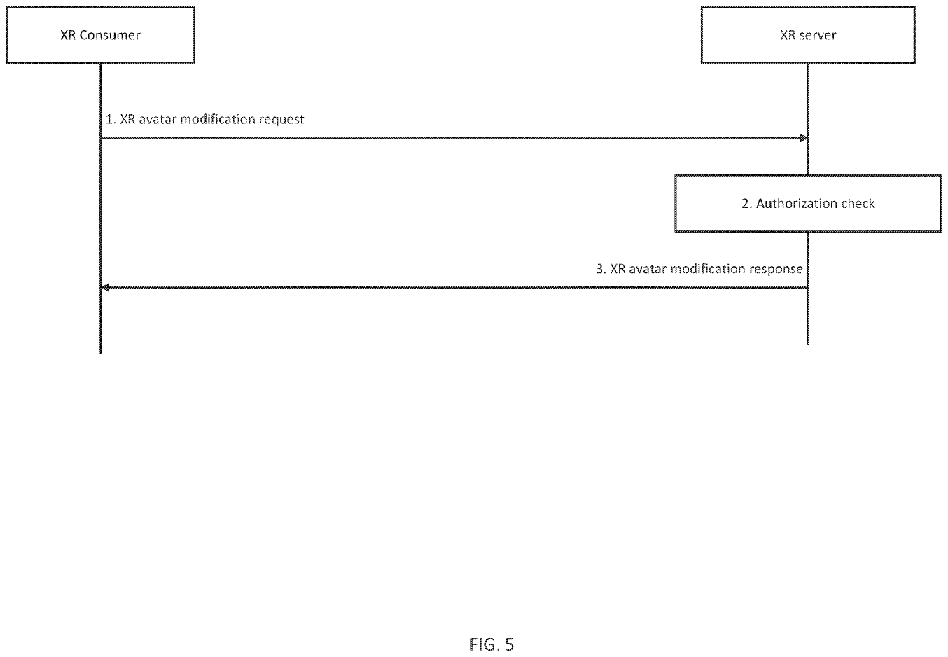

FIG. 5 shows an example method for a consumer to modify information in a digital avatar.

As shown in FIG. 5, in step 1, a consumer may need to modify information in an XR user's digital avatar, and the consumer may send a modification request to the XR server. The request may include one or more of the user identifier associated with the digital avatar, the avatar identifier, a consumer identifier, and the information with which to update the digital avatar. For example, the consumer may be a friend of the XR user and may desire to share the consumer's avatar identifier to connect with the XR user. The request may target the Friends list resource to create a new Avatar identifier for the consumer in the XR user's digital avatar.

In step 2, the XR server may check the authorization and access control policies to determine whether the consumer is authorized to modify information in the digital avatar and whether access control is allowed for the modification of the requested resource. If allowed, the XR server may update the information.

In step 3, if the authorization and access control checks are successful, the XR server may return a status to the request and may provide an indication that the digital avatar has been updated with the new information in a response sent to the consumer.

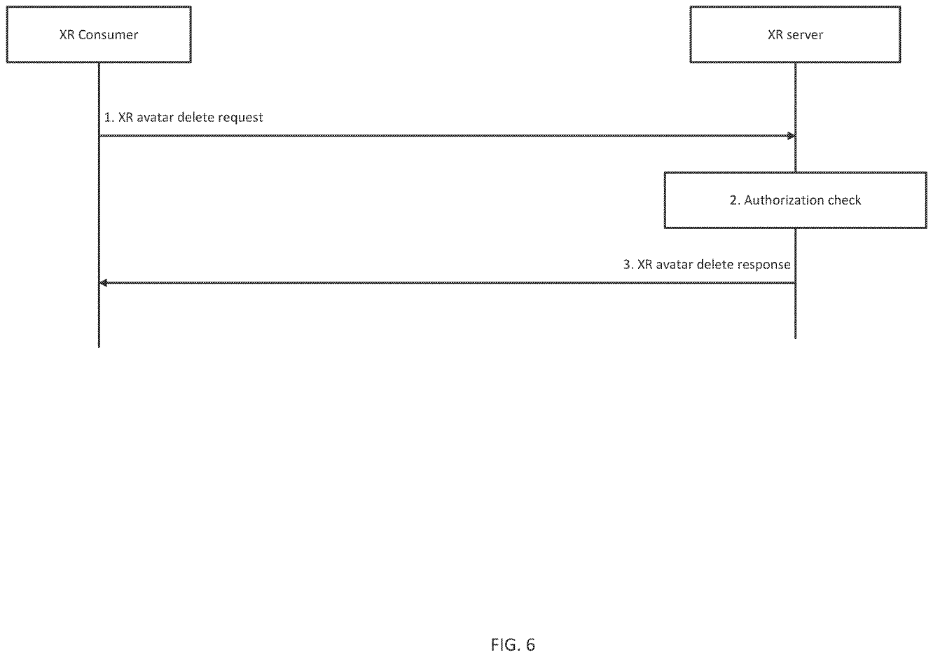

In the example method of FIG. 6, a consumer may want to delete information in a digital avatar. The consumer may be the owner of the digital avatar or may have access to delete certain information in the digital avatar. For example, an XR service provider may request to delete the avatar identifier of an employee who may no longer work for the XR service provider (e.g., the avatar owner may also be the consumer in this case to delete the avatar identifier).

As shown in FIG. 6, in step 1, a consumer may be able to delete information in a digital avatar such as the information listed in Table 1. The consumer may send a delete request to the XR server and, in the request, provide one or more of the user identifier associated with the digital avatar, the avatar identifier, a consumer identifier, and/or the information to delete. If the request is to delete all the information in the XR user's digital avatar, then only the user identifier may be included in the request without the avatar identifier. For cases in which external third-party consumers are deleting information from the digital avatar (e.g., an XR service provider or friend), the delete request may be limited to certain information in Table 1, e.g. according to an access control policy.

In step 2, the XR server may check the authorization and access control policies to determine whether the consumer is authorized to delete information from the digital avatar and whether access control is allowed to delete the information. The delete request may be specified to delete only certain IEs in the digital avatar or all the information in the digital avatar (e.g., as shown in Table 1).

In step 3, if the authorization and access control checks are successful, the XR server may return the status in a response to the request and an acknowledgement of the data that was deleted. The response may provide an error code if the request was not successful.

A subscription/notification mechanism may be employed to allow consumers to get notifications for changes to the digital avatar. The subscription event may be a certain operation is performed, a certain informational element is changed, an access by a certain avatar identifier and/or XR service provider, or an avatar certification and/or discovery is made to the digital avatar, the expiration of authorization or access control policy, etc.

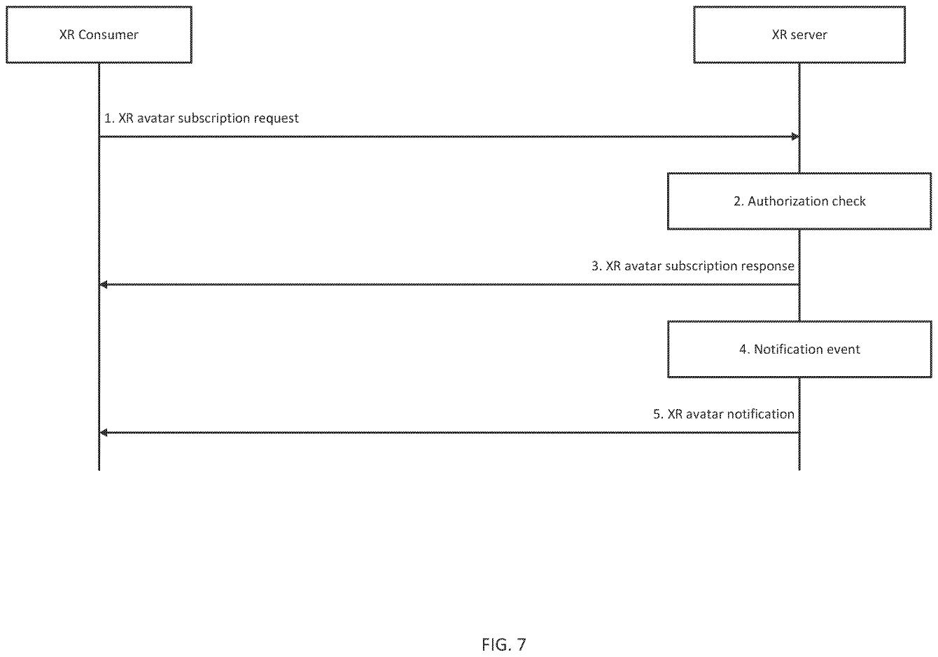

FIG. 7 shows an example method of digital avatar subscription/notification.

As shown in FIG. 7, in step 1, a consumer may subscribe to receive notifications from an XR server for changes to information in a digital avatar (e.g., such as those listed in Table 1). The consumer may send a request to the XR server and in the request provide one or more of the user identifier associated with the digital avatar, the avatar identifier, a consumer identifier, contact information of the consumer to send the notifications, an expiration time for the subscription, and a list of one or more subscription events to receive notifications from the XR server.

In step 2, the XR server may check the authorization and access control policies to determine whether the consumer is authorized to make subscriptions to the digital avatar and whether access control is allowed for the consumer to subscribe to the requested resource. If authorization and access control checks are successful, the XR server may create a subscription for the consumer.

In step 3, the XR server may return the status in a response to the request and may include a subscription identifier if a subscription event was created and the expiration time for the subscription. The XR server may include the subscription identifier in the notification messages that may be sent at a future time.

In step 4, a notification event may trigger based on a change to one of the information elements in the digital avatar or one of the other subscription events. The event may trigger the XR server to prepare a notification for the event and retrieve contact information for the subscriber.

In step 5, the XR server may send a notification message to the subscriber and may include in the request the subscription identifier and the information from the digital avatar that changed.

The owner of a digital avatar may subscribe to be notified of changes to the digital avatar. Subscription events may be defined such that notifications may be received for changes to information in the digital avatar, when an avatar certification or discovery is requested, upon expiration of an authorization policy, etc. A verification indicator may be provided for a subscription event in which the owner is notified to verify whether the digital avatar access is allowed. For example, the owner may be notified if another XR user or service provider is requesting to discover one of the owner's avatars or an XR user requesting to be added to the Family, Friends, or XR service providers list.

### XR Digital Avatar Certification

An XR user who may want to access XR services that may be required by the XR service provider to certify the XR user's digital avatar. Certification may serve different purposes, including one or more of authenticating and associating the XR user to a digital avatar, verifying the authenticity of user information within the digital avatar, and/or authorizing the retrieval of the XR user's digital avatar for use with the XR service.

An example method implemented by an extended reality server may comprise receiving a request to certify an XR user's digital avatar. The request may be received from an application server. The request may comprise one or more of a user identifier, user information, an avatar identifier, avatar source information, a certification indicator, an MFA level, and an identifier of the requestor.

The method may further comprise determining the requestor is authorized to request the certification of the XR user's digital avatar. This determination may be based on the user identifier or the avatar identifier.

The method may further comprise sending a request comprising one or more of a user identifier, user information, an avatar identifier, avatar source information, a certification indicator, a multi-factor authentication (MFA) level, a verification interval, and an identifier of the requestor. The request may be sent to an XR storage server.

The method may further comprise receiving a response comprising certification information and XR digital avatar information. The response my be received from the XR storage server.

The method may further comprise sending a response to the application server. The response may comprise information to certify the user identifier or the avatar identifier and the avatar source information. The information may be associated with the application server rendering the avatar in XR services. The avatar source may comprise one or more of a type of avatar, meta-data for the avatar, information on a rendering engine, and data to render the avatar for XR services.

An example method implemented by an extended reality client may comprise receiving a request. The request may be from an XR server to certify the XR user's digital avatar. The request may comprise one or more of a certification type, the identifier of the requestor, and the avatar identifier to certify. The certification type may comprise information associated with certifying the avatar and one or more of an image, a video, a location, an audio recording, and one or more sensor measurements.

The method may further comprise sending one or more requests for certification information of the XR user's digital avatar to one or more client applications.

The method may further comprise collecting certification information from the one or more client applications.

The method may further comprise sending the response comprising the certification information received from the one or more client applications. The response may be sent to the XR server.

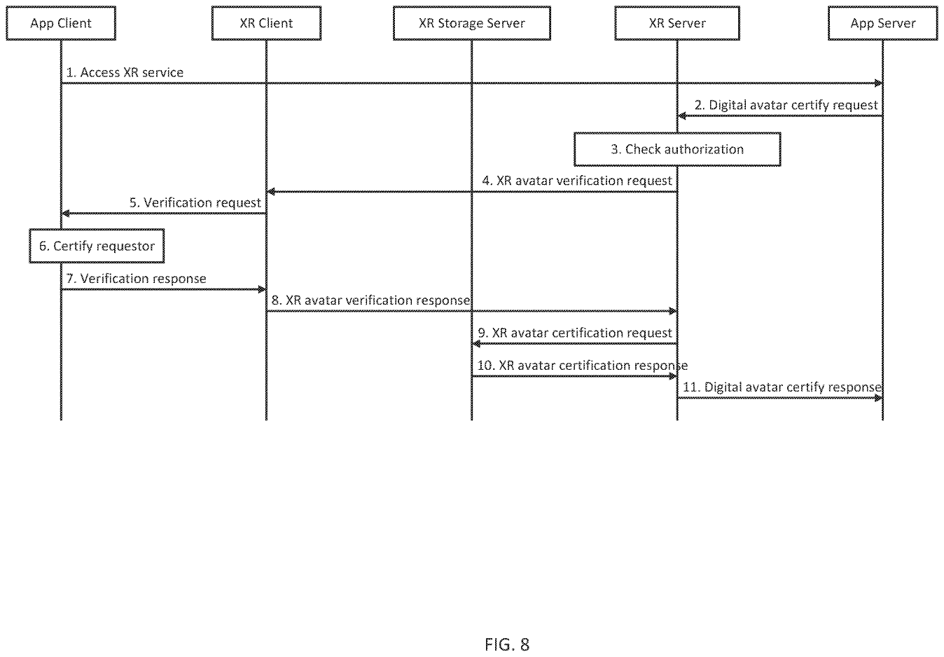

FIG. 8 shows an example method for the certification of an XR user's digital avatar with an XR service provider. The method described in FIG. 8 may assume that a vertical application enabler layer is present (e.g., represented by the XR client and XR server). In a deployment scenario in which a CSP provider is involved, the services provided by the XR client and XR server may be integrated in the application client and application server, respectively.

As shown in FIG. 8, in step 1, an XR user may want to access an XR service with a particular XR service provider, represented by the application server in the figure, and may provide information about the XR user's digital avatar for use with the XR service via an application client. Different requirements may be provided by the application client depending on the context of the XR service.

For example, the application client may provide the user identifier and/or user information and an avatar identifier to the XR service provider for initial registration with the XR service. As another example, the application client may only need to provide the avatar source to the service provider for an existing relationship with the service provider. If the XR service provider has stricter certification requirements, the application client may need to provide the user identifier, user information, avatar identifier, and avatar source to certify the XR user to the XR service provider. The application client may provide the XR service provider one or more of the user identifier, user information (e.g., name and address), avatar identifier, and avatar source to assist with the certification of the XR user's digital avatar.

The application client may identify an XR server which the XR service provider may contact to certify the XR user's digital avatar. Contact information may consist of one or more of an XR server identifier, an FQDN, a DNS name, or an IP address and port number.

In step 2, the XR service provider may make a request to the XR server to certify the digital avatar of the XR user. The request may be sent to the XR server identified in the request from the application client in step 1, using XR server discovery mechanisms, or from configured or local policies. The XR service provider request may include one or more of the user identifier, user information, the avatar identifier, the information about the source of the avatar such as the type and size of the digital avatar, a certification indicator, and an identifier for the requestor. The certification indicator may be in the form of an API call that identifies the request as a certification request. The identifier for the request may be the XR service provider identifier and/or an identifier of a digital avatar of another XR user (e.g., an XR user making a request to certify a digital avatar of another XR user).

In addition to the information provided for avatar certification, the XR service provider may also specify an MFA level with which to certify the XR user. The MFA level may specify how many sources of information are required to certify the XR user. Sources of certification information may be an image, a video, a location, an audio recording possibly with a spoken passphrase, one or more sensor measurements, etc.

The request from the XR service provider may be triggered independently of the request from the application client (e.g., as shown in step 1 of FIG. 8). The request as shown in Step 2 of FIG. 8 may be initiated based on one or more of policies, interactions with other servers including management and configuration servers, GUI interaction from a representative of an XR service provider, from other XR users, etc.

In step 3, the XR server may verify whether the XR service provider is authorized to check for the certification of the XR user's digital avatar. The XR server may communicate with an authorization entity, such as an XR authorization server or a core network function, to verify the XR service provider is authorized to access the XR user's digital avatar. The XR server may be provisioned with the authorization information and verify the authorization internally.

In step 4, the XR server may send verification requests to one or more XR clients to verify information for the digital avatar based on the MFA level. The request may include the certification type, e.g., what information is required for certification, the identifier of the requestor, and the avatar identifier the XR service provider is requesting to certify. FIG. 8 shows a request sent to one client (e.g., requests sent to other clients are not shown).

In step 5, the XR client may forward the information in the verification request to one or more of the application clients to provide the certification information. The XR client may be running on a smartphone and communicate to one or more application clients on external devices (e.g., external cameras, XR headsets, haptic gloves with fingerprint sensor, wearable devices, and other biometric sensors). There may be multiple application clients running on the smartphone that may provide certification information, such as location sensor, microphone, camera, and touchscreen interface to receive XR user input.

In step 6, the application client may prompt the XR user (e.g., using a GUI or pop-up notification) to certify the requestor can have access to the requested information in the digital avatar. For clients that may not have direct XR user control, the client may generate or capture the required information (e.g., an image, a video, a location, and one or more sensor measurements) that may be used for certification purposes.

In step 7, the XR user may indicate whether to grant the requestor access in the response sent to the XR client. The response may include the status and an authorization token to add the requestor to the certified IE of the corresponding list (e.g., family, friends, or XR service provider). The response may also include access control information for the requestor if such information was not available in the digital avatar.

In step 8, the XR client may forward the information from the verification response received from the application client to the XR server. Other clients may return the certification information separately or together with the XR client. For example, an XR user's smartphone may coordinate gathering certification information from nearby devices (e.g., cameras, XR glasses, wearable devices, etc.) and may aggregate the information into a single response sent to the XR server.

In step 9, once authorization is verified, the XR server may send a request to an XR storage service with the information provided by the application server, e.g., one or more of the user identifier, user information, avatar identifier, information about the avatar source, a certification indicator, and an identifier for the requestor. Moreover, the XR server may include information returned from the XR client to add the requestor to one of the lists (e.g., family, friends, and XR service provider) maintained in the digital avatar. In some aspects, steps 4 to 8 of FIG. 8 may be skipped. For example, MFA level may be configured as a single source which the XR server can fulfill. As another example, steps 4 to 8 of FIG. 8 may be skipped for certification of user information.

In step 10, the XR storage server may check the authorization and access control policies associated with the user identifier and/or avatar identifier to ensure the requestor identifier is authorized and has access control to certify the digital avatar. If the XR client has provided an authorization token, the authorization and access control checks may be skipped. If access is granted, the XR storage server may return certification information for the user identifier and/or avatar identifier and avatar source information for the XR service provider to generate the digital avatar of the XR user. The certification information may be that user information in the digital avatar matches those provided in the request or the avatar belongs to the XR user as identified by the user identifier or avatar identifier. Avatar source information may be returned to enable the XR service provider to render the XR user's digital avatar. The XR storage server may also update the information found in Table 1 (e.g., in the family, friends, or XR service provider list) using the requestor identifier.

In step 11, the XR server may return a response to the application server with the information to certify the digital avatar associated with the user identifier and/or avatar identifier received from the XR storage server in step 10. The XR server may also include the avatar source information to the application server for rendering the avatar in XR services.

The sequence of steps shown in FIG. 8 may be in a different order than what is shown. For example, steps 4 to 8 may be sent after steps 9 to 10 if the MFA level information is maintained by the XR storage server. The XR avatar certification request may be divided into separate requests, e.g., a request to check for authorization and access control, a request to verify user information in the digital avatar, and/or a request to retrieve avatar source information for rendering the digital avatar.

For each avatar identifier in the digital avatar, different MFA levels may be configured and associated with avatar certification. Associated with each MFA level may be one or more of a certification type, which specifies the information required to certify the avatar. Examples of certification type may be one or more of an image, a video, a location, an audio recording possibly with a spoken passphrase, one or more sensor measurements, etc. A single device such as a smartphone or multiple devices such as XR glasses and wearable devices may provide the certification information.

An XR user may make a request to certify the digital avatar of another XR user. Using FIG. 8 as an example and replacing the application server in the FIG. with XR user2, XR user2 may receive an avatar call from the XR client of XR user1. The XR user2 may execute the digital avatar certification steps as shown in steps 2 to 11 of FIG. 8.

### XR Digital Avatar Discovery

An XR user may want to search for the presence of digital avatars of other XR users in online activities. For example, the XR user may be searching for a good friend, a new classmate, or an acquaintance the XR user had recently met at a virtual networking event. The XR user may be good friends with another XR user and may have already exchanged avatar identifiers with each other. The new classmate may provide a discovery token to pre-authorize the discovery of the classmate's avatar. The XR user may want to befriend the new acquaintance and may only have the acquaintance's avatar name or description.

An example method implemented by extended reality client may comprise receiving a first request from an application client. The first request may comprise one or more of an avatar identifier, an avatar name, an avatar description, or a discovery token associated with an XR user's digital avatar. The first request may be associated with discovering the XR user's digital avatar.

The method may further comprise sending a second request to an XR server. The second request may comprise one or more of an avatar identifier, an avatar name, an avatar description, and a discovery token associated with discovering the XR user's digital avatar. The second request may further comprise a user identifier, the avatar identifier of the XR user, and an indication for avatar discovery.

The method may further comprise receiving a response to the second request. The response may comprise a status of the second request, and one or more of the avatar identifier, avatar name, avatar status, and information about the avatar source.

The method may further comprise sending a response to the first request. The response to the first request may indicate discovery of the XR user's digital avatar and the information received in the response to the second request.

An example method implemented by an extended reality server may comprise receiving a first request from an XR client. The first request may comprise one or more of an avatar identifier, an avatar name, an avatar description, and a discovery token associated with an XR user's digital avatar. The request may be associated with discovering the status of the digital avatar.

The method may further comprise performing a search associated with finding one or more matches for the avatar identifier, the avatar name, or the avatar description from a local repository.

The method may further comprise determining one or more second avatar identifiers based on matching the search criteria.

The method may further comprise sending one or more requests to one or more storage servers associated with storage of the XR user's digital avatar. The one or more requests may comprise one or more of an identifier of the requestor, the avatar identifier, the avatar name, the avatar description, and the discovery token.

The method may further comprise receiving one or more response to the one or more requests. The one or more responses may comprise at least one of a status of the request, the avatar identifier, the avatar name, the status of the digital avatar, and avatar source information.

The method may further comprise sending a response to the first request. The response may indicate discovery of the XR user's digital avatar, and the information received in the one or more response to the one or more requests.

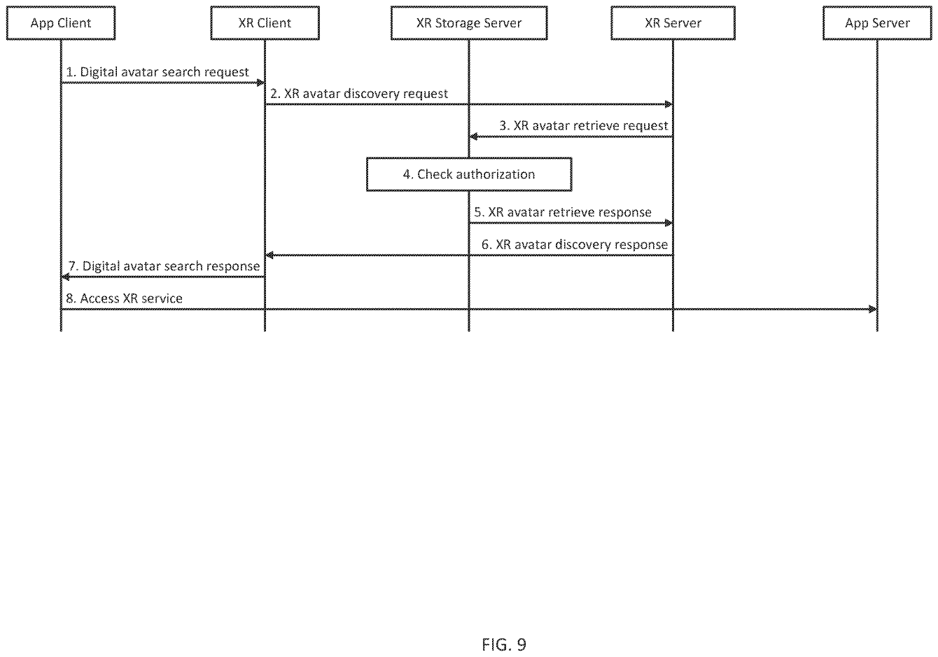

As shown in FIG. 9, the XR user may utilize the XR discovery method to locate other XR users.

As shown in FIG. 9, in step 1, an XR user may, using a client application, make a request to an XR client to search for another XR user. The XR user may have obtained the other XR user's avatar identifier, avatar name, avatar description, and/or discovery token to provide in the request. The avatar identifier may be shared between and among family and friends while the avatar name, avatar description, and discovery token may be obtained during a previous XR encounter, e.g., in an XR social hour or networking event.

In step 2, the XR client may send a request to an XR server to search for an avatar that is associated with the avatar identifier, avatar name, avatar description, and/or discovery token. The XR client may also include one or more of the user identifier, the avatar identifier of the XR user, and an indication for avatar discovery. The discovery indicator may be in the form of an API call that identifies the request as an avatar discovery request.

In step 3, the XR server may perform a search for an avatar with a match to one of the provided information: avatar identifier, avatar name, avatar description, and/or discovery token. The XR server may have certain index information (e.g., avatar identifiers, avatar names, and/or avatar description from Table 1) of digital avatars stored locally. For example, the search may generate one or multiple matches depending on what information was provided in the search criteria. For example, if only the avatar name or avatar description was provided, there may be more than one match depending on the uniqueness of the name or whether the avatar description was too general for a single match with a unique avatar. However, if an avatar identifier or discovery token was provided, then the match may locate a single, unique avatar. The result of the search may also identify one or more XR storage servers that may host the information corresponding to the discovered avatars. If the XR server is able to find a match, the XR server may send a request to retrieve discovery information from the one or more XR storage servers. The request may include one or more of the identifier of the requestor and the discovery information: avatar identifier, avatar name, avatar description, and/or discovery token.

In step 4, the XR storage server may check if the requestor has authorization to discover the indicated avatar. The discovery token, if provided, may serve as a temporary authorization token, and may bypass the authorization step(s). If authorization is successful, the XR storage server may retrieve the necessary discovery information to return to the XR server. The authorization check may also be performed by the XR server prior to sending the retrieve request in step 3 of FIG. 9. The discovery information may be different depending on the search criteria. If either the avatar name or avatar description was provided, the avatar identifier and status may be returned as discovery information. If an avatar identifier was provided as the search criteria, the avatar status and/or the avatar location may be returned. User information may also be returned if allowed by access control configurations.

In step 5, the XR storage server may provide a response to the XR server. The response may include one or more of the statuses of the request, the avatar identifier and name, information about the avatar source, and the avatar status. Other information from Table 1 may also be provided, e.g., pending access control configurations.

In step 6, the XR server may return the information received from the XR storage server to the XR client.

In step 7, the XR client may return the information received from the XR server to the client application and may indicate whether the avatar was successfully discovered.

In step 8, if the avatar status revealed the discovered avatar is online, the XR user of the client application may access the XR service provided in the avatar status to convene with the other XR user.

The methods shown in FIG. 8 and FIG. 9 may depict different entities performing the authorization step. For example, in FIG. 8, the XR server performs the authorization and, in FIG. 9, the XR storage server performs the authorization. The entity performing the authorization step may depend on the deployment scenario and/or the capabilities of the storage server. For example, the storage server may only serve as a repository for storing information of digital avatars. In another example, the storage server may also have the ability to perform authorization. The XR server and/or XR storage server functionalities may be logical functions and may be combined into one physical XR server.

An XR service provider represented as an application server may perform avatar discovery on behalf of XR users. An XR user (e.g., using XR services provided by the XR service provider) may initiate the avatar discovery step(s) to invite another user (e.g., a friend) to join the XR service. The XR service provider may then execute steps 1 to 7 of FIG. 9 on behalf of the XR user.

### EXAMPLES

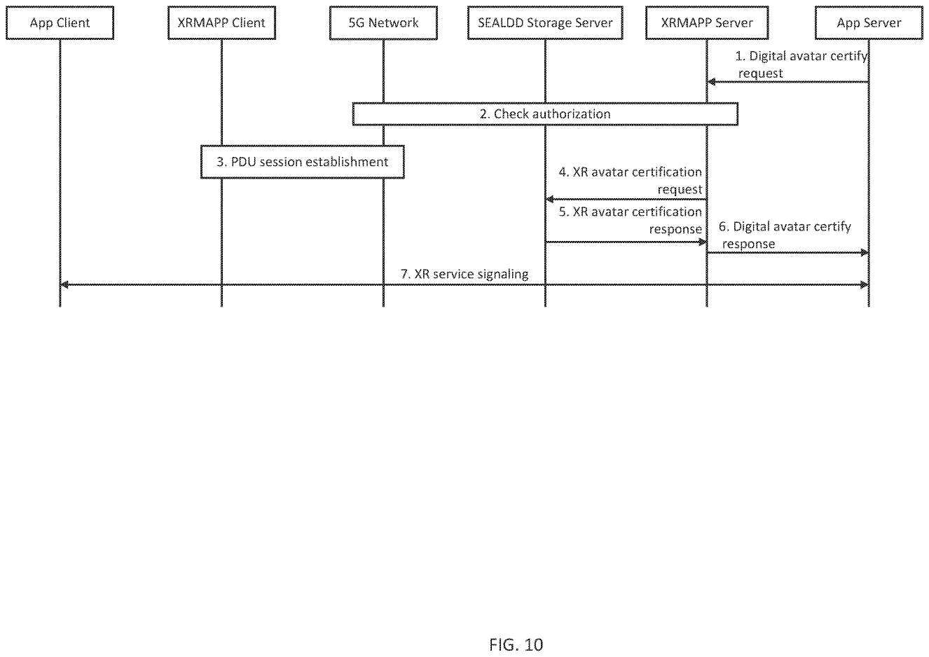

An MNO example may be realized with the functionalities according to the present disclosure. FIG. 10 shows an example of a 3GPP implementation of the avatar certification method shown in FIG. 8. For example, an MNO may define a vertical application enabler layer, XRMAPP, that provide digital avatar services associated with XR services. Third-party XR service providers may be represented by the application server shown in FIG. 10 and may obtain digital avatar certifications from the XRMAPP layer. An XR user may interface with the application client, which may use the services offered by the XRMAPP layer through the XRMAPP client. Both the application client and the XRMAPP client may run on a user equipment, or UE. For example, a UE may be a smartphone the XR user is using to receive XR services.

As shown in FIG. 10, in step 1, an XR service provider, represented as the application server in the figure, may make a request to certify the digital avatar of an XR user. The application server may provide one or more of the application server ID, an application ID, contact information of the application server, the user and/or avatar identifier, an indicator (or associate API call) for avatar certification, and QoS requirements. The user identifier may be associated with that of a user equipment identifier and the application ID may indicate what type of service is required for the XR user to participate in the XR service. The application server may have been provisioned with contact information of the XRMAPP server or may have discovered the XRMAPP server through one or more other discovery methods.

In step 2, the XRMAPP server may check with the 5G network for the authorization of the application server to request for the avatar certification. As part of the authorization check (or independent of the authorization check), the XRMAPP server may provide the 5G network QoS information for the XR service, which may trigger the creation or update of URSP rules in the UE (e.g., not shown in FIG. 10). This step may be divided into multiple steps but are shown as one step in the figure.

In step 3, using the newly created or updated URSP rule, the UE may request to establish a PDU session with the 5G network to use the XR services.

In steps 4-5, the XRMAPP server may interact with the SEALDD storage server as described by steps 9-10 of FIG. 8. In this case, the SEALDD storage server may be offering similar functionality as that of the XR storage server.

In step 6, the XRMAPP server may return a response to the application server (e.g., similar to step 11 of FIG. 8).

In step 7, using application layer signaling, the XR user may verify the continued use of the digital avatar according to the verification interval configured for the digital avatar.

The method shown in FIG. 10 may differ from the method shown in FIG. 8 and may provide another aspect of how the avatar certification may be realized. The method shown in FIG. 10 may be modified to perform avatar discovery similar to the method shown in FIG. 9 and may provide another example of how the avatar discovery may be realized. The XRMAPP layer may be designed to support the case where the XRMAPP server may send a request to the XRMAPP client (e.g., similar to steps 4 to 8 of FIG. 8). Other aspects may also be envisioned.

### Graphical User Interface

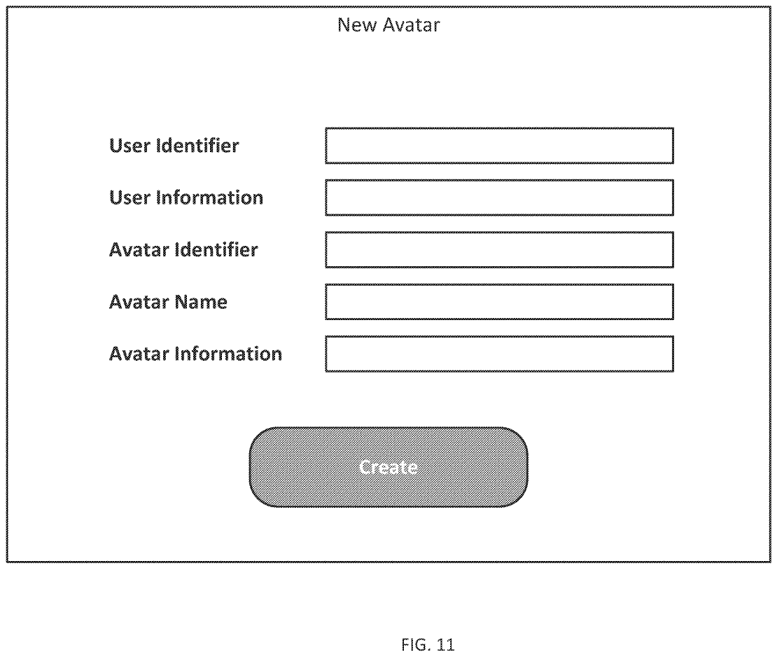

FIG. 11 shows an example graphical user interface (GUI) that an application client may present to an XR user for information to create a digital avatar. The requested information may reflect some or all the informational elements presented in Table 1. In some deployments, the avatar identifier may need to be unique and/or may be assigned by a digital avatar provider. For example, the user identifier may be a log in identifier of the XR user in a CSP deployment or it may be a UE identifier in an MNO deployment.

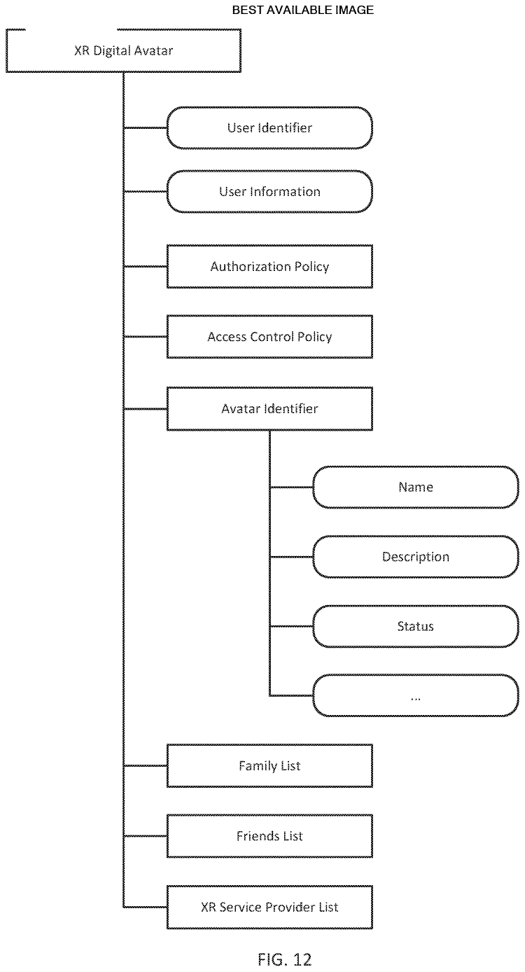

Upon the creation of a digital avatar, an XR server may create a resource structure such as the example shown in FIG. 12. The resource structure, also referred to as a RESTful resource tree, may be composed of collection resources (rectangular boxes) and attributes (rounded rectangular boxes). The collection resources may contain sub-collection resources and attributes. The attributes contain information about the parent resource, e.g., the User information attribute may contain information about the XR user that is associated with the XR digital avatar resource. Similarly, the Name attribute may describe the name given to the parent resource Avatar identifier.

The XR server may combine individual resource structures of different user identifiers together into a larger tree structure where the parent resource may be labeled as the “root” resource. The XR server may also structure the information in a different format, e.g., to align with a database structure.

### Example Communications System

The 3rd Generation Partnership Project (3GPP) develops technical standards for cellular telecommunications network technologies, including radio access, the core transport network, and service capabilities-including work on codecs, security, and quality of service. Recent radio access technology (RAT) standards include WCDMA (commonly referred as 3G), LTE (commonly referred as 4G), LTE-Advanced standards, and New Radio (NR), which is also referred to as “5G”. 3GPP NR standards development is expected to continue and include the definition of next generation radio access technology (new RAT), which is expected to include the provision of new flexible radio access below 7 GHZ, and the provision of new ultra-mobile broadband radio access above 7 GHz. The flexible radio access is expected to consist of a new, non-backwards compatible radio access in new spectrum below 7 GHz, and it is expected to include different operating modes that may be multiplexed together in the same spectrum to address a broad set of 3GPP NR use cases with diverging requirements. The ultra-mobile broadband is expected to include cmWave and mmWave spectrum that may provide the opportunity for ultra-mobile broadband access for, e.g., indoor applications and hotspots. In particular, the ultra-mobile broadband is expected to share a common design framework with the flexible radio access below 7 GHz, with cmWave and mmWave specific design optimizations.

3GPP has identified a variety of use cases that NR is expected to support, resulting in a wide variety of user experience requirements for data rate, latency, and mobility. The use cases include the following general categories: enhanced mobile broadband (eMBB) ultra-reliable low-latency Communication (URLLC), massive machine type communications (mMTC), network operation (e.g., network slicing, routing, migration and interworking, energy savings), and enhanced vehicle-to-everything (eV2X) communications, which may include any of Vehicle-to-Vehicle Communication (V2V), Vehicle-to-Infrastructure Communication (V2I), Vehicle-to-Network Communication (V2N), Vehicle-to-Pedestrian Communication (V2P), and vehicle communications with other entities. Specific service and applications in these categories include, e.g., monitoring and sensor networks, device remote controlling, bi-directional remote controlling, personal cloud computing, video streaming, wireless cloud-based office, first responder connectivity, automotive ecall, disaster alerts, real-time gaming, multi-person video calls, autonomous driving, augmented reality, tactile internet, virtual reality, home automation, robotics, and aerial drones to name a few. All of these use cases and others are contemplated herein.

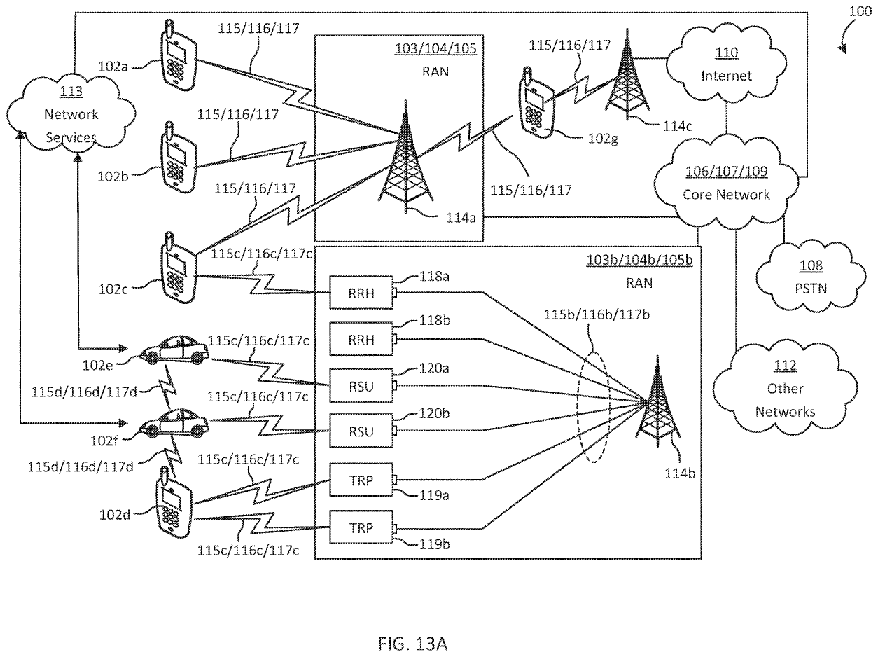

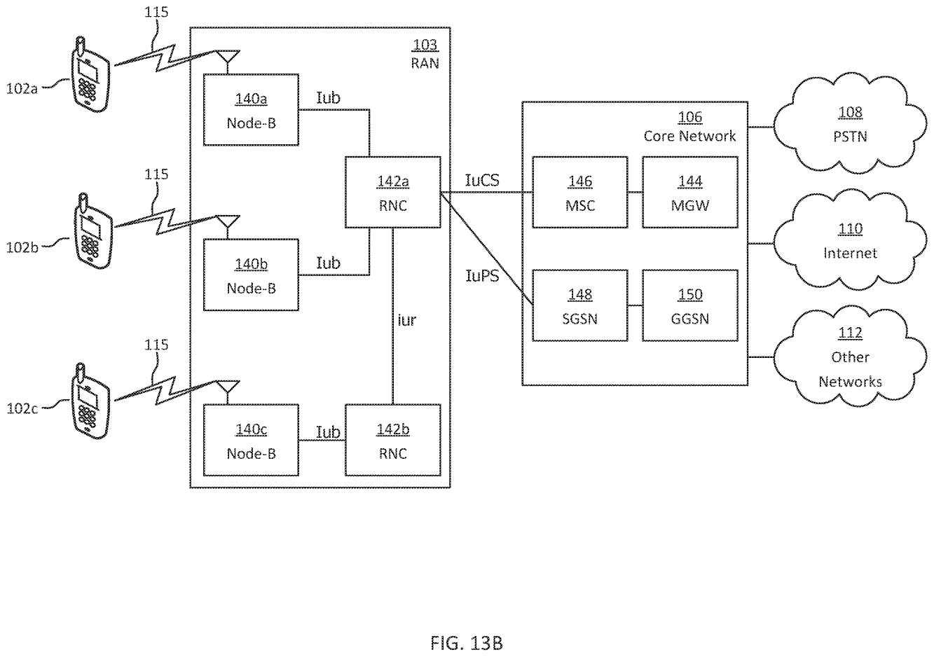

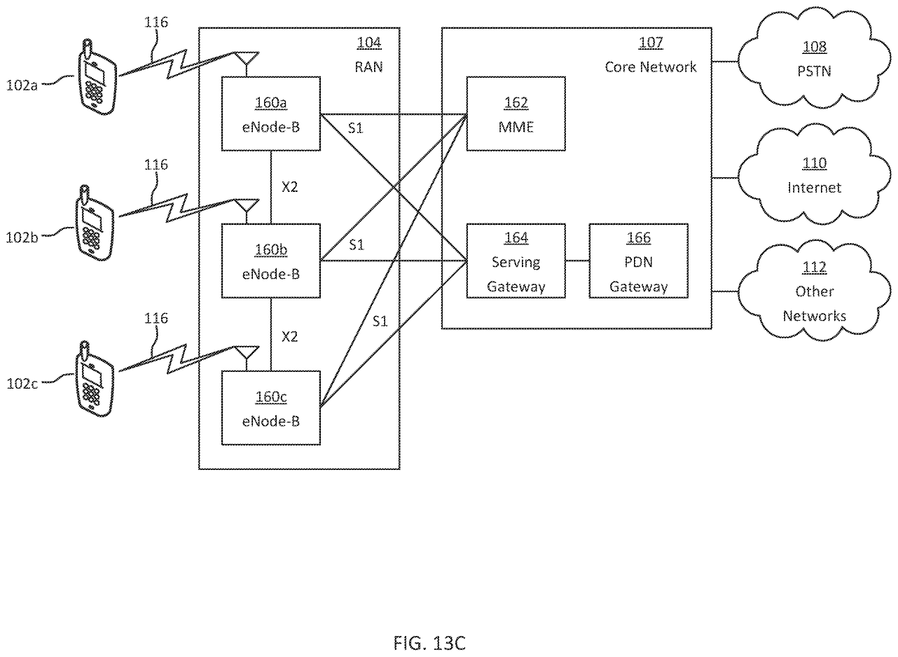

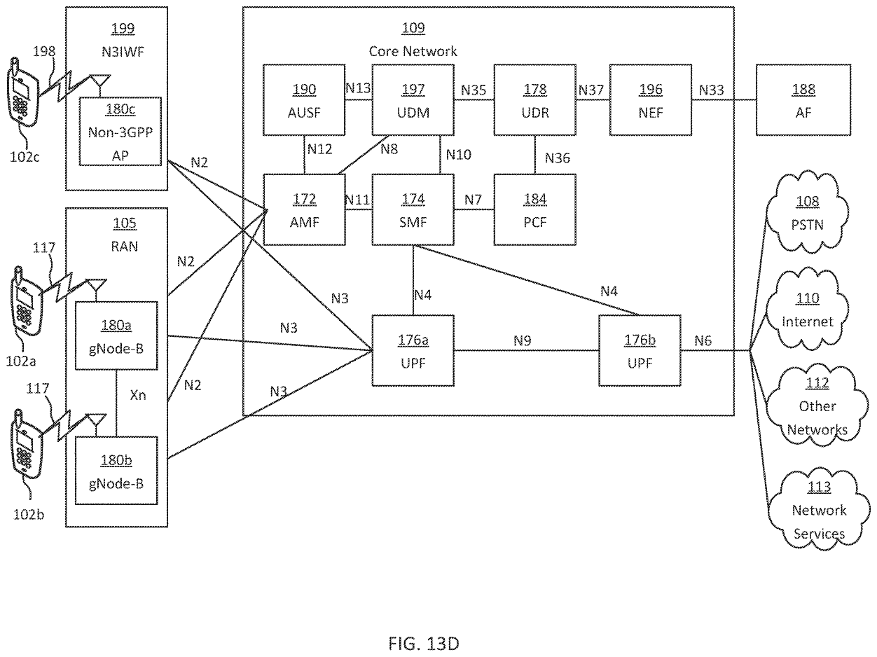

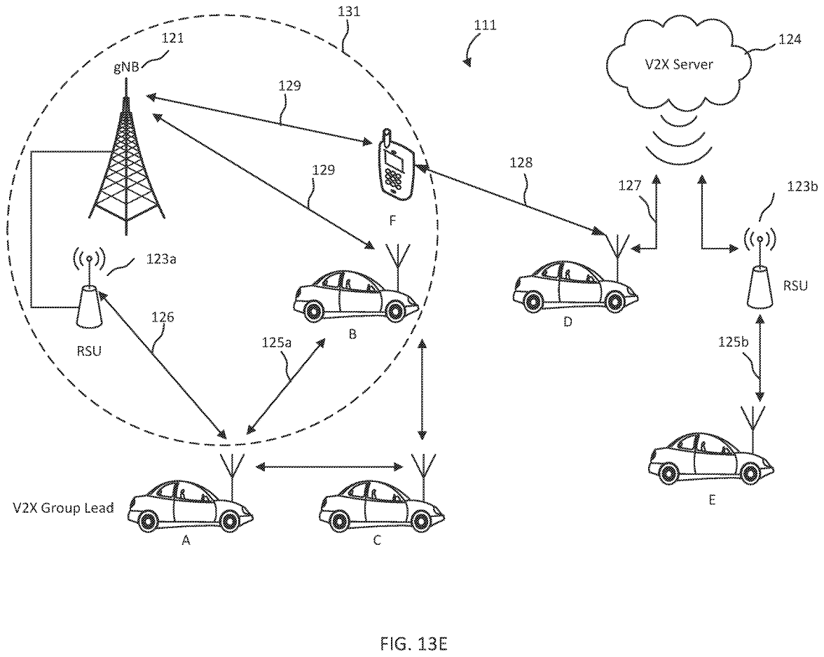

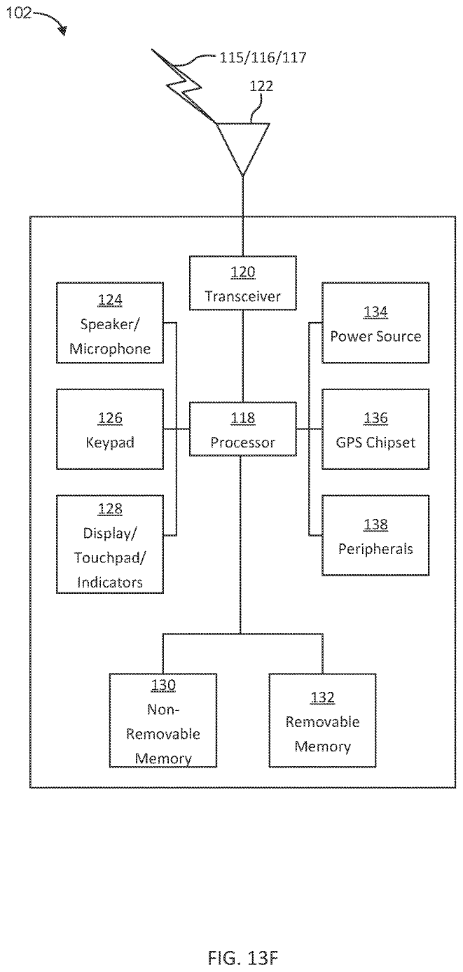

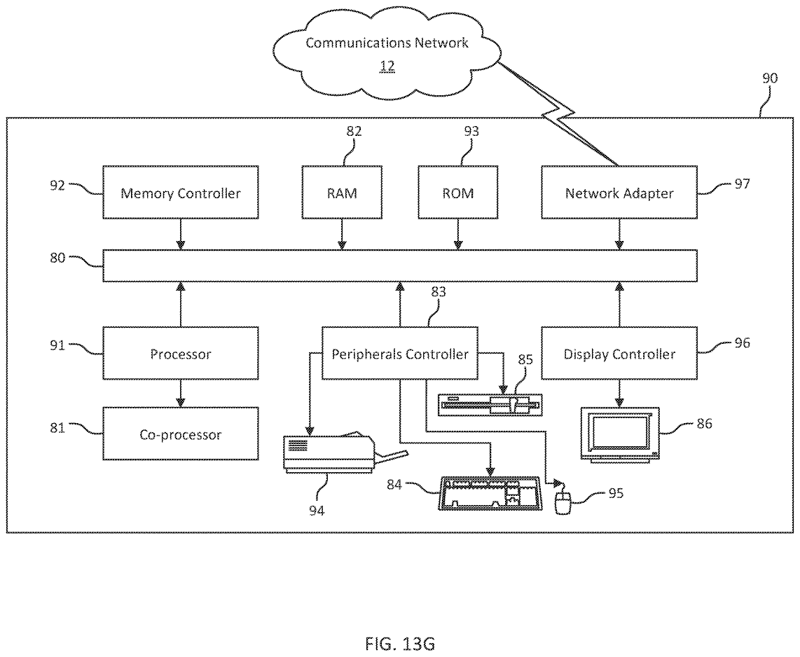

FIG. 13A illustrates an example communications system 100 in which the systems, methods, and apparatuses described and claimed herein may be used. The communications system 100 may include wireless transmit/receive units (WTRUs) 102a, 102b, 102c, 102d, 102e, 102f, and/or 102g, which generally or collectively may be referred to as WTRU 102 or WTRUs 102. The communications system 100 may include, a radio access network (RAN) 103/104/105/103b/104b/105b, a core network 106/107/109, a public switched telephone network (PSTN) 108, the Internet 110, other networks 112, and Network Services 113. 113. Network Services 113 may include, for example, a V2X server, V2X functions, a ProSe server, ProSe functions, IoT services, video streaming, and/or edge computing, etc.

It may be appreciated that the concepts disclosed herein may be used with any number of WTRUs, base stations, networks, and/or network elements. Each of the WTRUs 102 may be any type of apparatus or device configured to operate and/or communicate in a wireless environment. In the example of FIG. 13A, each of the WTRUs 102 is depicted in FIG. 8A-8E as a hand-held wireless communications apparatus. It is understood that with the wide variety of use cases contemplated for wireless communications, each WTRU may comprise or be included in any type of apparatus or device configured to transmit and/or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, bus or truck, a train, or an airplane, and the like.

The communications system 100 may also include a base station 114a and a base station 114b. In the example of FIG. 13A, each base stations 114a and 114b is depicted as a single element. In practice, the base stations 114a and 114b may include any number of interconnected base stations and/or network elements. Base stations 114a may be any type of device configured to wirelessly interface with at least one of the WTRUs 102a, 102b, and 102c to facilitate access to one or more communication networks, such as the core network 106/107/109, the Internet 110, Network Services 113, and/or the other networks 112. Similarly, base station 114b may be any type of device configured to wiredly and/or wirelessly interface with at least one of the Remote Radio Heads (RRHs) 118a, 118b, Transmission and Reception Points (TRPs) 119a, 119b, and/or Roadside Units (RSUs) 120a and 120b to facilitate access to one or more communication networks, such as the core network 106/107/109, the Internet 110, other networks 112, and/or Network Services 113. RRHs 118a, 118b may be any type of device configured to wirelessly interface with at least one of the WTRUs 102, e.g., WTRU 102c, to facilitate access to one or more communication networks, such as the core network 106/107/109, the Internet 110, Network Services 113, and/or other networks 112.

TRPs 119a, 119b may be any type of device configured to wirelessly interface with at least one of the WTRU 102d, to facilitate access to one or more communication networks, such as the core network 106/107/109, the Internet 110, Network Services 113, and/or other networks 112. RSUs 120a and 120b may be any type of device configured to wirelessly interface with at least one of the WTRU 102e or 102f, to facilitate access to one or more communication networks, such as the core network 106/107/109, the Internet 110, other networks 112, and/or Network Services 113. By way of example, the base stations 114a, 114b may be a Base Transceiver Station (BTS), a Node-B, an eNode B, a Home Node B, a Home eNode B, a Next Generation Node-B (gNode B), a satellite, a site controller, an access point (AP), a wireless router, and the like.

The base station 114a may be part of the RAN 103/104/105, which may also include other base stations and/or network elements (not shown), such as a Base Station Controller (BSC), a Radio Network Controller (RNC), relay nodes, etc. Similarly, the base station 114b may be part of the RAN 103b/104b/105b, which may also include other base stations and/or network elements (not shown), such as a BSC, a RNC, relay nodes, etc. The base station 114a may be configured to transmit and/or receive wireless signals within a particular geographic region, which may be referred to as a cell (not shown). Similarly, the base station 114b may be configured to transmit and/or receive wired and/or wireless signals within a particular geographic region, which may be referred to as a cell (not shown). The cell may further be divided into cell sectors. For example, the cell associated with the base station 114a may be divided into three sectors. Thus, for example, the base station 114a may include three transceivers, e.g., one for each sector of the cell. The base station 114a may employ Multiple-Input Multiple Output (MIMO) technology and, therefore, may utilize multiple transceivers for each sector of the cell, for instance.

The base station 114a may communicate with one or more of the WTRUs 102a, 102b, 102c, and 102g over an air interface 115/116/117, which may be any suitable wireless communication link (e.g., Radio Frequency (RF), microwave, infrared (IR), ultraviolet (UV), visible light, cmWave, mmWave, etc.). The air interface 115/116/117 may be established using any suitable Radio Access Technology (RAT).

The base station 114b may communicate with one or more of the RRHs 118a and 118b, TRPs 119a and 119b, and/or RSUs 120a and 120b, over a wired or air interface 115b/116b/117b, which may be any suitable wired (e.g., cable, optical fiber, etc.) or wireless communication link (e.g., RF, microwave, IR, UV, visible light, cmWave, mmWave, etc.). The air interface 115b/116b/117b may be established using any suitable RAT.

The RRHs 118a, 118b, TRPs 119a, 119b and/or RSUs 120a, 120b, may communicate with one or more of the WTRUs 102c, 102d, 102e, 102f over an air interface 115c/116c/117c, which may be any suitable wireless communication link (e.g., RF, microwave, IR, ultraviolet UV, visible light, cmWave, mmWave, etc.) The air interface 115c/116c/117c may be established using any suitable RAT.

The WTRUs 102 may communicate with one another over a direct air interface 115d/116d/117d, such as Sidelink communication which may be any suitable wireless communication link (e.g., RF, microwave, IR, ultraviolet UV, visible light, cmWave, mmWave, etc.) The air interface 115d/116d/117d may be established using any suitable RAT.

The communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b, TRPs 119a, 119b and/or RSUs 120a and 120b in the RAN 103b/104b/105b and the WTRUs 102c, 102d, 102e, and 102f, may implement a radio technology such as Universal Mobile Telecommunications System (UMTS) Terrestrial Radio Access (UTRA), which may establish the air interface 115/116/117 and/or 115c/116c/117c respectively using Wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

The base station 114a in the RAN 103/104/105 and the WTRUs 102a, 102b, 102c, and 102g, or RRHs 118a and 118b, TRPs 119a and 119b, and/or RSUs 120a and 120b in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) and/or LTE-Advanced (LTE-A), for example. The air interface 115/116/117 or 115c/116c/117c may implement 3GPP NR technology. The LTE and LTE-A technology may include LTE D2D and/or V2X technologies and interfaces (such as Sidelink communications, etc.) Similarly, the 3GPP NR technology may include NR V2X technologies and interfaces (such as Sidelink communications, etc.)

The base station 114a in the RAN 103/104/105 and the WTRUs 102a, 102b, 102c, and 102g or RRHs 118a and 118b, TRPs 119a and 119b, and/or RSUs 120a and 120b in the RAN 103b/104b/105b and the WTRUs 102c, 102d, 102e, and 102f may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 13A may be a wireless router, Home Node B, Home eNode B, or access point, for example, and may utilize any suitable RAT for facilitating wireless connectivity in a localized area, such as a place of business, a home, a vehicle, a train, an aerial, a satellite, a manufactory, a campus, and the like. The base station 114c and the WTRUs 102, e.g., WTRU 102e, may implement a radio technology such as IEEE 802.11 to establish a Wireless Local Area Network (WLAN). Similarly, the base station 114c and the WTRUs 102, e.g., WTRU 102d, may implement a radio technology such as IEEE 802.15 to establish a wireless personal area network (WPAN). The base station 114c and the WTRUs 102, e.g., WRTU 102e, may utilize a cellular-based RAT (e.g., WCDMA, CDMA2000, GSM, LTE, LTE-A, NR, etc.) to establish a picocell or femtocell. As shown in FIG. 13A, the base station 114c may have a direct connection to the Internet 110. Thus, the base station 114c may not be required to access the Internet 110 via the core network 106/107/109.

The RAN 103/104/105 and/or RAN 103b/104b/105b may be in communication with the core network 106/107/109, which may be any type of network configured to provide voice, data, messaging, authorization and authentication, applications, and/or Voice Over Internet Protocol (VOIP) services to one or more of the WTRUs 102. For example, the core network 106/107/109 may provide call control, billing services, mobile location-based services, pre-paid calling, Internet connectivity, packet data network connectivity, Ethernet connectivity, video distribution, etc., and/or perform high-level security functions, such as user authentication.

Although not shown in FIG. 13A, it may be appreciated that the RAN 103/104/105 and/or RAN 103b/104b/105b and/or the core network 106/107/109 may be in direct or indirect communication with other RANs that employ the same RAT as the RAN 103/104/105 and/or RAN 103b/104b/105b or a different RAT. For example, in addition to being connected to the RAN 103/104/105 and/or RAN 103b/104b/105b, which may be utilizing an E-UTRA radio technology, the core network 106/107/109 may also be in communication with another RAN (not shown) employing a GSM or NR radio technology.

The core network 106/107/109 may also serve as a gateway for the WTRUs 102 to access the PSTN 108, the Internet 110, and/or other networks 112. The PSTN 108 may include circuit-switched telephone networks that provide Plain Old Telephone Service (POTS). The Internet 110 may include a global system of interconnected computer networks and devices that use common communication protocols, such as the Transmission Control Protocol (TCP), User Datagram Protocol (UDP), and the internet protocol (IP) in the TCP/IP internet protocol suite. The other networks 112 may include wired or wireless communications networks owned and/or operated by other service providers. For example, the networks 112 may include any type of packet data network (e.g., an IEEE 802.3 Ethernet network) or another core network connected to one or more RANs, which may employ the same RAT as the RAN 103/104/105 and/or RAN 103b/104b/105b or a different RAT.

Some or all of the WTRUs 102a, 102b, 102c, 102d, 102e, and 102f in the communications system 100 may include multi-mode capabilities, e.g., the WTRUs 102a, 102b, 102c, 102d, 102e, and 102f may include multiple transceivers for communicating with different wireless networks over different wireless links. For example, the WTRU 102g shown in FIG. 13A may be configured to communicate with the base station 114a, which may employ a cellular-based radio technology, and with the base station 114c, which may employ an IEEE 802 radio technology.

Although not shown in FIG. 13A, it may be appreciated that a User Equipment may make a wired connection to a gateway. The gateway maybe a Residential Gateway (RG). The RG may provide connectivity to a Core Network 106/107/109. It may be appreciated that many of the ideas contained herein may equally apply to UEs that are WTRUs and UEs that use a wired connection to connect to a network. For example, the ideas that apply to the wireless interfaces 115, 116, 117 and 115c/116c/117c may equally apply to a wired connection.

FIG. 13B is a system diagram of an example RAN 103 and core network 106. As noted above, the RAN 103 may employ a UTRA radio technology to communicate with the WTRUs 102a, 102b, and 102c over the air interface 115. The RAN 103 may also be in communication with the core network 106. As shown in FIG. 13B, the RAN 103 may include Node-Bs 140a, 140b, and 140c, which may each include one or more transceivers for communicating with the WTRUs 102a, 102b, and 102c over the air interface 115. The Node-Bs 140a, 140b, and 140c may each be associated with a particular cell (not shown) within the RAN 103. The RAN 103 may also include RNCs 142a, 142b. It may be appreciated that the RAN 103 may include any number of Node-Bs and Radio Network Controllers (RNCs.)

As shown in FIG. 13B, the Node-Bs 140a, 140b may be in communication with the RNC 142a. Additionally, the Node-B 140c may be in communication with the RNC 142b. The Node-Bs 140a, 140b, and 140c may communicate with the respective RNCs 142a and 142b via an Iub interface. The RNCs 142a and 142b may be in communication with one another via an Iur interface. Each of the RNCs 142a and 142b may be configured to control the respective Node-Bs 140a, 140b, and 140c to which it is connected. In addition, each of the RNCs 142a and 142b may be configured to carry out or support other functionality, such as outer loop power control, load control, admission control, packet scheduling, handover control, macro-diversity, security functions, data encryption, and the like.

The core network 106 shown in FIG. 13B may include a media gateway (MGW) 144, a Mobile Switching Center (MSC) 146, a Serving GPRS Support Node (SGSN) 148, and/or a Gateway GPRS Support Node (GGSN) 150. While each of the foregoing elements are depicted as part of the core network 106, it may be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, and 102c with access to circuit-switched networks, such as the PSTN 108, to facilitate communications between the WTRUs 102a, 102b, and 102c, and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, and 102c with access to packet-switched networks, such as the Internet 110, to facilitate communications between and the WTRUs 102a, 102b, and 102c, and IP-enabled devices.

The core network 106 may also be connected to the other networks 112, which may include other wired or wireless networks that are owned and/or operated by other service providers.

FIG. 13C is a system diagram of an example RAN 104 and core network 107. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, and 160c, though it may be appreciated that the RAN 104 may include any number of eNode-Bs. The eNode-Bs 160a, 160b, and 160c may each include one or more transceivers for communicating with the WTRUs 102a, 102b, and 102c over the air interface 116. For example, the eNode-Bs 160a, 160b, and 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink and/or downlink, and the like. As shown in FIG. 13C, the eNode-Bs 160a, 160b, and 160c may communicate with one another over an X2 interface.

The core network 107 shown in FIG. 13C may include a Mobility Management Gateway (MME) 162, a serving gateway 164, and a Packet Data Network (PDN) gateway 166. While each of the foregoing elements are depicted as part of the core network 107, it may be appreciated that any one of these elements may be owned and/or operated by an entity other than the core network operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, and 102c, bearer activation/deactivation, selecting a particular serving gateway during an initial attach of the WTRUs 102a, 102b, and 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the S1 interface. The serving gateway 164 may generally route and forward user data packets to/from the WTRUs 102a, 102b, and 102c. The serving gateway 164 may also perform other functions, such as anchoring user planes during inter-eNode B handovers, triggering paging when downlink data is available for the WTRUs 102a, 102b, and 102c, managing and storing contexts of the WTRUs 102a, 102b, and 102c, and the like.

The serving gateway 164 may also be connected to the PDN gateway 166, which may provide the WTRUs 102a, 102b, and 102c with access to packet-switched networks, such as the Internet 110, to facilitate communications between the WTRUs 102a, 102b, 102c, and IP-enabled devices.

The core network 107 may facilitate communications with other networks. For example, the core network 107 may provide the WTRUs 102a, 102b, and 102c with access to circuit-switched networks, such as the PSTN 108, to facilitate communications between the WTRUs 102a, 102b, and 102c and traditional land-line communications devices. For example, the core network 107 may include, or may communicate with, an IP gateway (e.g., an IP Multimedia Subsystem (IMS) server) that serves as an interface between the core network 107 and the PSTN 108. In addition, the core network 107 may provide the WTRUs 102a, 102b, and 102c with access to the networks 112, which may include other wired or wireless networks that are owned and/or operated by other service providers.

FIG. 13D is a system diagram of an example RAN 105 and core network 109. The RAN 105 may employ an NR radio technology to communicate with the WTRUs 102a and 102b over the air interface 117. The RAN 105 may also be in communication with the core network 109. A Non-3GPP Interworking Function (N3IWF) 199 may employ a non-3GPP radio technology to communicate with the WTRU 102c over the air interface 198. The N3IWF 199 may also be in communication with the core network 109.

The RAN 105 may include gNode-Bs 180a and 180b. It may be appreciated that the RAN 105 may include any number of gNode-Bs. The gNode-Bs 180a and 180b may each include one or more transceivers for communicating with the WTRUs 102a and 102b over the air interface 117. When integrated access and backhaul connection are used, the same air interface may be used between the WTRUs and gNode-Bs, which may be the core network 109 via one or multiple gNBs. The gNode-Bs 180a and 180b may implement MIMO, MU-MIMO, and/or digital beamforming technology. Thus, the gNode-B 180a, for example, may use multiple antennas to transmit wireless signals to, and receive wireless signals from, the WTRU 102a. It should be appreciated that the RAN 105 may employ of other types of base stations such as an eNode-B. It may also be appreciated the RAN 105 may employ more than one type of base station. For example, the RAN may employ eNode-Bs and gNode-Bs.

The N3IWF 199 may include a non-3GPP Access Point 180c. It may be appreciated that the N3IWF 199 may include any number of non-3GPP Access Points. The non-3GPP Access Point 180c may include one or more transceivers for communicating with the WTRUs 102c over the air interface 198. The non-3GPP Access Point 180c may use the 802.11 protocol to communicate with the WTRU 102c over the air interface 198.

Each of the gNode-Bs 180a and 180b may be associated with a particular cell (not shown) and may be configured to handle radio resource management decisions, handover decisions, scheduling of users in the uplink and/or downlink, and the like. As shown in FIG. 13D, the gNode-Bs 180a and 180b may communicate with one another over an Xn interface, for example.

The core network 109 shown in FIG. 13D may be a 5G core network (5GC). The core network 109 may offer numerous communication services to customers who are interconnected by the radio access network. The core network 109 comprises a number of entities that perform the functionality of the core network. As used herein, the term “core network entity” or “network function” refers to any entity that performs one or more functionalities of a core network. It is understood that such core network entities may be logical entities that are implemented in the form of computer-executable instructions (software) stored in a memory of, and executing on a processor of, an apparatus configured for wireless and/or network communications or a computer system, such as system 90 illustrated in FIG. 13G.

In the example of FIG. 13D, the 5G Core Network 109 may include an access and mobility management function (AMF) 172, a Session Management Function (SMF) 174, User Plane Functions (UPFs) 176a and 176b, a User Data Management Function (UDM) 197, an Authentication Server Function (AUSF) 190, a Network Exposure Function (NEF) 196, a Policy Control Function (PCF) 184, a Non-3GPP Interworking Function (N3IWF) 199, a User Data Repository (UDR) 178. While each of the foregoing elements are depicted as part of the 5G core network 109, it may be appreciated that any one of these elements may be owned and/or operated by an entity other than the core network operator. It may also be appreciated that a 5G core network may not consist of all of these elements, may consist of additional elements, and may consist of multiple instances of each of these elements. FIG. 13D shows that network functions directly connect to one another, however, it should be appreciated that they may communicate via routing agents such as a diameter routing agent or message buses.

In the example of FIG. 13D, connectivity between network functions is achieved via a set of interfaces, or reference points. It may be appreciated that network functions may be modeled, described, or implemented as a set of services that are invoked, or called, by other network functions or services. Invocation of a Network Function service may be achieved via a direct connection between network functions, an exchange of messaging on a message bus, calling a software function, etc.

The AMF 172 may be connected to the RAN 105 via an N2 interface and may serve as a control node. For example, the AMF 172 may be responsible for registration management, connection management, reachability management, access authentication, access authorization. The AMF may be responsible forwarding user plane tunnel configuration information to the RAN 105 via the N2 interface. The AMF 172 may receive the user plane tunnel configuration information from the SMF via an N11 interface. The AMF 172 may generally route and forward NAS packets to/from the WTRUs 102a, 102b, and 102c via an N1 interface. The N1 interface is not shown in FIG. 13D.

The SMF 174 may be connected to the AMF 172 via an N11 interface. Similarly, the SMF may be connected to the PCF 184 via an N7 interface, and to the UPFs 176a and 176b via an N4 interface. The SMF 174 may serve as a control node. For example, the SMF 174 may be responsible for Session Management, IP address allocation for the WTRUs 102a, 102b, and 102c, management and configuration of traffic steering rules in the UPF 176a and UPF 176b, and generation of downlink data notifications to the AMF 172.

The UPF 176a and UPF 176b may provide the WTRUs 102a, 102b, and 102c with access to a Packet Data Network (PDN), such as the Internet 110, to facilitate communications between the WTRUs 102a, 102b, and 102c and other devices. The UPF 176a and UPF 176b may also provide the WTRUs 102a, 102b, and 102c with access to other types of packet data networks. For example, Other Networks 112 may be Ethernet Networks or any type of network that exchanges packets of data. The UPF 176a and UPF 176b may receive traffic steering rules from the SMF 174 via the N4 interface. The UPF 176a and UPF 176b may provide access to a packet data network by connecting a packet data network with an N6 interface or by connecting to each other and to other UPFs via an N9 interface. In addition to providing access to packet data networks, the UPF 176 may be responsible packet routing and forwarding, policy rule enforcement, quality of service handling for user plane traffic, downlink packet buffering.

The AMF 172 may also be connected to the N3IWF 199, for example, via an N2 interface. The N3IWF facilitates a connection between the WTRU 102c and the 5G core network 170, for example, via radio interface technologies that are not defined by 3GPP. The AMF may interact with the N3IWF 199 in the same, or similar, manner that it interacts with the RAN 105.

The PCF 184 may be connected to the SMF 174 via an N7 interface, connected to the AMF 172 via an N15 interface, and to an Application Function (AF) 188 via an N5 interface. The N15 and N5 interfaces are not shown in FIG. 13D. The PCF 184 may provide policy rules to control plane nodes such as the AMF 172 and SMF 174, allowing the control plane nodes to enforce these rules. The PCF 184, may send policies to the AMF 172 for the WTRUs 102a, 102b, and 102c so that the AMF may deliver the policies to the WTRUs 102a, 102b, and 102c via an N1 interface. Policies may then be enforced, or applied, at the WTRUs 102a, 102b, and 102c.

The UDR 178 may act as a repository for authentication credentials and subscription information. The UDR may connect to network functions, so that network function may add to, read from, and modify the data that is in the repository. For example, the UDR 178 may connect to the PCF 184 via an N36 interface. Similarly, the UDR 178 may connect to the NEF 196 via an N37 interface, and the UDR 178 may connect to the UDM 197 via an N35 interface.

The UDM 197 may serve as an interface between the UDR 178 and other network functions. The UDM 197 may authorize network functions to access of the UDR 178. For example, the UDM 197 may connect to the AMF 172 via an N8 interface, the UDM 197 may connect to the SMF 174 via an N10 interface. Similarly, the UDM 197 may connect to the AUSF 190 via an N13 interface. The UDR 178 and UDM 197 may be tightly integrated.

The AUSF 190 performs authentication related operations and connects to the UDM 178 via an N13 interface and to the AMF 172 via an N12 interface.

The NEF 196 exposes capabilities and services in the 5G core network 109 to Application Functions (AF) 188. Exposure may occur on the N33 API interface. The NEF may connect to an AF 188 via an N33 interface and it may connect to other network functions in order to expose the capabilities and services of the 5G core network 109.

Application Functions 188 may interact with network functions in the 5G Core Network 109. Interaction between the Application Functions 188 and network functions may be via a direct interface or may occur via the NEF 196. The Application Functions 188 may be considered part of the 5G Core Network 109 or may be external to the 5G Core Network 109 and deployed by enterprises that have a business relationship with the mobile network operator.

Network Slicing is a mechanism that may be used by mobile network operators to support one or more ‘virtual’ core networks behind the operator's air interface. This involves ‘slicing’ the core network into one or more virtual networks to support different RANs or different service types running across a single RAN. Network slicing enables the operator to create networks customized to provide optimized solutions for different market scenarios which demands diverse requirements, e.g., in the areas of functionality, performance and isolation.

3GPP has designed the 5G core network to support Network Slicing. Network Slicing is a good tool that network operators may use to support the diverse set of 5G use cases (e.g., massive IoT, critical communications, V2X, and enhanced mobile broadband) which demand very diverse and sometimes extreme requirements. Without the use of network slicing techniques, it is likely that the network architecture would not be flexible and scalable enough to efficiently support a wider range of use cases need when each use case has its own specific set of performance, scalability, and availability requirements. Furthermore, introduction of new network services should be made more efficient.

Referring again to FIG. 13D, in a network slicing scenario, a WTRU 102a, 102b, or 102c may connect to an AMF 172, via an N1 interface. The AMF may be logically part of one or more slices. The AMF may coordinate the connection or communication of WTRU 102a, 102b, or 102c with one or more UPF 176a and 176b, SMF 174, and other network functions. Each of the UPFs 176a and 176b, SMF 174, and other network functions may be part of the same slice or different slices. When they are part of different slices, they may be isolated from each other in the sense that they may utilize different computing resources, security credentials, etc.

The core network 109 may facilitate communications with other networks. For example, the core network 109 may include, or may communicate with, an IP gateway, such as an IP Multimedia Subsystem (IMS) server, that serves as an interface between the 5G core network 109 and a PSTN 108. For example, the core network 109 may include, or communicate with a short message service (SMS) service center that facilities communication via the short message service. For example, the 5G core network 109 may facilitate the exchange of non-IP data packets between the WTRUs 102a, 102b, and 102c and servers or applications functions 188. In addition, the core network 170 may provide the WTRUs 102a, 102b, and 102c with access to the networks 112, which may include other wired or wireless networks that are owned and/or operated by other service providers.

The core network entities described herein and illustrated in FIGS. 8A, 8C, 8D, and 8E are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIGS. 8A, 8B, 8C, 8D, and 8E are provided by way of example only, and it is understood that the subject matter disclosed and claimed herein may be embodied or implemented in any similar communication system, whether presently defined or defined in the future.

FIG. 13E illustrates an example communications system 111 in which the systems, methods, apparatuses described herein may be used. Communications system 111 may include Wireless Transmit/Receive Units (WTRUs) A, B, C, D, E, F, a base station gNB 121, a V2X server 124, and Road Side Units (RSUs) 123a and 123b. In practice, the concepts presented herein may be applied to any number of WTRUs, base station gNBs, V2X networks, and/or other network elements. One or several or all WTRUs A, B, C, D, E, and F may be out of range of the access network coverage 131. WTRUs A, B, and C form a V2X group, among which WTRU A is the group lead and WTRUs B and Care group members.

WTRUs A, B, C, D, E, and F may communicate with each other over a Uu interface 129 via the gNB 121 if they are within the access network coverage 131. In the example of FIG. 13E, WTRUs B and F are shown within access network coverage 131. WTRUs A, B, C, D, E, and F may communicate with each other directly via a Sidelink interface (e.g., PC5 or NR PC5) such as interface 125a, 125b, or 128, whether they are under the access network coverage 131 or out of the access network coverage 131. For instance, in the example of FIG. 13E, WRTUD, which is outside of the access network coverage 131, communicates with WTRU F, which is inside the coverage 131.

WTRUs A, B, C, D, E, and F may communicate with RSU 123a or 123b via a Vehicle-to-Network (V2N) 133 or Sidelink interface 125b. WTRUs A, B, C, D, E, and F may communicate to a V2X Server 124 via a Vehicle-to-Infrastructure (V2I) interface 127. WTRUs A, B, C, D, E, and F may communicate to another UE via a Vehicle-to-Person (V2P) interface 128.

FIG. 13F is a block diagram of an example apparatus or device WTRU 102 that may be configured for wireless communications and operations in accordance with the systems, methods, and apparatuses described herein, such as a WTRU 102 of FIG. 13A, 8B, 8C, 8D, or 8E. As shown in FIG. 13F, the example WTRU 102 may include a processor 118, a transceiver 120, a transmit/receive element 122, a speaker/microphone 124, a keypad 126, a display/touchpad/indicators 128, non-removable memory 130, removable memory 132, a power source 134, a global positioning system (GPS) chipset 136, and other peripherals 138. It may be appreciated that the WTRU 102 may include any sub-combination of the foregoing elements. Also, the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, a next generation node-B (gNode-B), and proxy nodes, among others, may include some or all of the elements depicted in FIG. 13F and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 13F depicts the processor 118 and the transceiver 120 as separate components, it may be appreciated that the processor 118 and the transceiver 120 may be integrated together in an electronic package or chip.

The transmit/receive element 122 of a UE may be configured to transmit signals to, or receive signals from, a base station (e.g., the base station 114a of FIG. 13A) over the air interface 115/116/117 or another UE over the air interface 115d/116d/117d. For example, the transmit/receive element 122 may be an antenna configured to transmit and/or receive RF signals. The transmit/receive element 122 may be an emitter/detector configured to transmit and/or receive IR, UV, or visible light signals, for example. The transmit/receive element 122 may be configured to transmit and receive both RF and light signals. It may be appreciated that the transmit/receive element 122 may be configured to transmit and/or receive any combination of wireless or wired signals.

In addition, although the transmit/receive element 122 is depicted in FIG. 13F as a single element, the WTRU 102 may include any number of transmit/receive elements 122. More specifically, the WTRU 102 may employ MIMO technology. Thus, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, for example NR and IEEE 802.11 or NR and E-UTRA, or to communicate with the same RAT via multiple beams to different RRHs, TRPs, RSUs, or nodes.

The processor 118 of the WTRU 102 may be coupled to, and may receive user input data from, the speaker/microphone 124, the keypad 126, and/or the display/touchpad/indicators 128 (e.g., a liquid crystal display (LCD) display unit or organic light-emitting diode (OLED) display unit. The processor 118 may also output user data to the speaker/microphone 124, the keypad 126, and/or the display/touchpad/indicators 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. The processor 118 may access information from, and store data in, memory that is not physically located on the WTRU 102, such as on a server that is hosted in the cloud or in an edge computing platform or in a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries, solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It may be appreciated that the WTRU 102 may acquire location information by way of any suitable location-determination method.

The processor 118 may further be coupled to other peripherals 138, which may include one or more software and/or hardware modules that provide additional features, functionality, and/or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be included in other apparatuses or devices, such as a sensor, consumer electronics, a wearable device such as a smart watch or smart clothing, a medical or eHealth device, a robot, industrial equipment, a drone, a vehicle such as a car, truck, train, or an airplane. The WTRU 102 may connect to other components, modules, or systems of such apparatuses or devices via one or more interconnect interfaces, such as an interconnect interface that may comprise one of the peripherals 138.

FIG. 13G is a block diagram of an exemplary computing system 90 in which one or more apparatuses of the communications networks illustrated in FIGS. 8A, 8C, 8D and 8E may be embodied, such as certain nodes or functional entities in the RAN 103/104/105, Core Network 106/107/109, PSTN 108, Internet 110, Other Networks 112, or Network Services 113. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, and/or any other functionality that enables the computing system 90 to operate in a communications network. Coprocessor 81 is an optional processor, distinct from main processor 91, that may perform additional functions or assist processor 91. Processor 91 and/or coprocessor 81 may receive, generate, and process data related to the methods and apparatuses disclosed herein.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that may not easily be modified. Data stored in RAM 82 may be read or changed by processor 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it may not access memory within another process's virtual address space unless memory sharing between the processes has been set up.

In addition, computing system 90 may contain peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain communication circuitry, such as for example a wireless or wired network adapter 97, that may be used to connect computing system 90 to an external communications network or devices, such as the RAN 103/104/105, Core Network 106/107/109, PSTN 108, Internet 110, WTRUs 102, or Other Networks 112 of FIGS. 8A, 8B, 8C, 8D, and 8E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

It is understood that any or all of the apparatuses, systems, methods and processes described herein may be embodied in the form of computer executable instructions (e.g., program code) stored on a computer-readable storage medium which instructions, when executed by a processor, such as processors 118 or 91, cause the processor to perform and/or implement the systems, methods and processes described herein. Specifically, any of the steps, operations, or functions described herein may be implemented in the form of such computer executable instructions, executing on the processor of an apparatus or computing system configured for wireless and/or wired network communications. Computer readable storage media includes volatile and nonvolatile, removable and non-removable media implemented in any non-transitory (e.g., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information and which may be accessed by a computing system.

What is claimed is:

1. A method for use by an extended reality (XR) client, the method comprising:
receiving, from one or more application clients or application servers, a message comprising information associated with creating a digital avatar of an XR user, wherein the digital avatar comprises a medium for the XR user to interact with one or more other XR users in one or more XR services;
sending, to an XR server, a request to create the digital avatar of the XR user, wherein the request comprises a user identifier configured to facilitate authenticating and authorization of the XR user, and one or more of other user information, an avatar name, an avatar description, information and associated metadata associated with creating the digital avatar of the XR user, an authorization policy, an access control policy, an avatar status, a multi-factor authentication (MFA) level, a verification interval, a discoverable indicator, a discoverable level, a certification resource, a location, a schedule, avatar source information, a family list, a friends list, or an XR service providers list, wherein the avatar source information comprises one or more of a type, metadata, a rendering engine, or avatar data for rendering; and
receiving, from the XR server, a response comprising a status of the request and stored information associated with the digital avatar of the XR user, wherein the stored information comprises at least an avatar identifier associated with the digital avatar of the XR user.

2. The method of claim 1, wherein the information and associated metadata associated with creating the digital avatar of the XR user comprises one or more of an image, a video, a location, an audio recording, and one or more sensor measurements.

3. The method of claim 1, wherein each of the one or more application clients or application servers are associated with a separate device, and wherein the separate device may be one of a smartphone, an external camera, or a wearable sensor device.

4. The method of claim 1, wherein the stored information associated with the digital avatar of the XR user is stored on an external XR storage server associated with the XR server.

5. The method of claim 1, wherein one or more other users identified in one of the family list, the friends list, or the XR service provider list have access to the avatar of the XR user.

6. The method of claim 1, further comprising causing creation, by a rendering engine based on the user identifier and the one or more of the other user information, the avatar name, the avatar description, the information and associated metadata associated with creating the digital avatar of the XR user, the authorization policy, the access control policy, the avatar status, the multi-factor authentication (MFA) level, the verification interval, the discoverable indicator, the discoverable level, the certification resource, the location, the schedule, the avatar source information, the family list, the friends list, or the XR service providers list, of the digital avatar of the XR user, wherein the rendering engine outputs well-defined and formatted data associated with rendering the digital avatar of the XR user.

7. The method of claim 6, wherein the causing creation of the digital avatar of the XR user is further based on a determination, based on the user identifier, that the one or more application clients are authorized to request creation of the digital avatar of the XR user.

8. The method of claim 1, wherein the other user information comprises one or more of a name associated with the XR user, an address associated with the XR user, height associated with the XR user, weight associated with the XR user, date of birth associated with the XR user, and nationality associated with the XR user.

9. The method of claim 1, wherein the user identifier configured to facilitate authenticating and authorization of the XR user is associated with a security policy, wherein the security policy comprises the authorization policy and the access control policy specifying the type of access control and the information a requestor has access to.

10. A method implemented by an extended reality (XR) server, the method comprising:
receiving, from one or more XR clients, one or more requests to create a digital avatar of an XR user comprising a user identifier configured to facilitate authenticating and authorization of the XR user, and one or more of other user information, an avatar name, an avatar description, information and associated metadata associated with creating a digital avatar of the XR user, an authorization policy, an access control policy, an avatar status, a multi-factor authentication (MFA) level, a verification interval, a discoverable indicator, a discoverable level, a certification resource, a location, a schedule, avatar source information, a family list, a friends list, or an XR service providers list, wherein the digital avatar comprises a medium for the XR user to interact with one or more other XR users in one or more XR services, and wherein the avatar source information comprises one or more of a type, metadata, a rendering engine, or avatar data for rendering;
determining, based on the user identifier, that the one or more XR clients are authorized to request creation of the digital avatar of the XR user;
assigning an avatar identifier for the digital avatar of the XR user;
storing the avatar identifier and well-defined and formatted data associated with rendering the digital avatar of the XR user; and
sending one or more responses to the XR clients, wherein the responses comprise a status for the one or more requests and stored information, wherein the stored information comprises at least the avatar identifier.

11. The method of claim 10, wherein the information and associated metadata associated with creating the digital avatar of the XR user comprises one or more of an image, a video, a location, an audio recording, and one or more sensor measurements.

12. The method of claim 10, wherein the stored information sent in the one or more responses further comprises one or more of the well-defined and formatted data, the avatar name, type and size, and information of a rendering engine capable of processing the well-defined and formatted data.

13. The method of claim 10, wherein each of the one or more XR clients are associated with a separate device, and wherein the separate device may be one of a smartphone, an external camera, or a wearable sensor device.

14. The method of claim 10, wherein the avatar identifier and well-defined and formatted data associated with rendering the digital avatar of the XR user are stored on an external XR storage server associated with the XR server.

15. The method of claim 10, wherein the avatar identifier and well-defined and formatted data associated with rendering the digital avatar of the XR user are stored on the XR server.

16. The method of claim 10, further comprising causing creation, by a rendering engine based on the user identifier and the one or more of the other user information, the avatar name, the avatar description, the information and associated metadata associated with creating the digital avatar of the XR user, the authorization policy, the access control policy, the avatar status, the multi-factor authentication (MFA) level, the verification interval, the discoverable indicator, the discoverable level, the certification resource, the location, the schedule, the avatar source information, the family list, the friends list, or the XR service providers list, of the digital avatar of the XR user, wherein the rendering engine outputs the well-defined and formatted data associated with rendering the digital avatar of the XR user.

17. The method of claim 16, wherein the causing creation of the digital avatar of the XR user is further based on the authenticating and authorizing the one or more XR clients.

18. The method of claim 10, wherein the other user information comprises one or more of a name associated with the XR user, an address associated with the XR user, height associated with the XR user, weight associated with the XR user, date of birth associated with the XR user, and nationality associated with the XR user.

19. The method of claim 10, wherein the user identifier configured to facilitate authenticating and authorization of the XR user is associated with a security policy, wherein the security policy comprises the authorization policy and the access control policy specifying the type of access control and the information a requestor has access to.

20. The method of claim 10, wherein one or more other users identified in one of the family list, the friends list, or the XR service provider list have access to the avatar of the XR user.
